(19) United States
(12) Patent Application Publication
(10) Pub. No.: US 2012/0185718 A1
(43) Pub. Date: Jul. 19, 2012

(54) POWER MANAGEMENT SYSTEM, POWER MANAGEMENT APPARATUS, NETWORK MANAGEMENT APPRATUS, INFORMATION PROCESSING APPARATUS, PROGRAM, POWER MANAGEMENT METHOD, AND INFORMATION PROCESSING METHOD

(75) Inventor: Hidekazu Miyoshi, Osaka-shi (JP)

(73) Assignee: SUMITOMO ELECTRIC INDUSTRIES, LTD., Osaka-shi (JP)

(21) Appl. No.: 13/498,796

(22) PCT Filed: Oct. 4, 2010
(86) PCT No.: PCT/JP2010/067391

§ 371 Date: Apr. 4, 2012

(30) Foreign Application Priority Data
Oct. 7, 2009 (JP) 2009-233676
Oct. 7, 2009 (JP) 2009-233677

(51) Int. Cl. G06F 1/32; G06F 15/173; G06F 1/26

(52) U.S. Cl. 713/323; 713/300; 709/223

(57) ABSTRACT

There are provided a power management system, a power management apparatus, a program, and a power management method that perform power management of terminal apparatuses connected to a network, while ensuring user convenience. A power management system 1 is a power management system that manages power states of apparatuses and includes one or a plurality of end terminals, one or a plurality of shared terminals, and a power management apparatus 10. The power management apparatus 10 holds correspondence information in which one or a plurality of specific end terminals among the one or plurality of end terminals are associated with one or a plurality of specific shared terminals performing data communication with the specific shared terminals among the one or plurality of shared terminals, and obtains information about power states of the specific end terminals and controls power states of the specific shared terminals based on the information.

### TECHNICAL FIELD

The present invention relates to a power management system, a power management apparatus, a network management apparatus, an information processing apparatus, a program, a power management method, and an information processing method.

### BACKGROUND ART

Due to the recent year's network technology development, there has been an increasing tendency in the number of electronic devices used on networks in offices, homes, etc. Despite this, in many cases, terminals shared in a network are powered on all the time, which causes an increase in power consumption. Accordingly, there is a demand for power saving techniques for suppressing unnecessary power consumption of network terminals.

The following Patent Literature 1 discloses an electric power control method that performs power saving control of client terminals by an electric power management server collectively performing the setting of power saving control of the client terminals. The electric power management server monitors the client terminals connected to a network and performs power saving control. When a client terminal is disconnected from the network, the electric power management server performs power saving control of the client terminal based on the setting of power saving control which is set in advance on the client terminal.

### CITATION LIST

### Patent Literature

Patent Literature 1: Japanese Patent No. 4260853

### SUMMARY OF INVENTION

### Technical Problem

The electric power control method of the above-described Patent Literature 1 is to perform power saving control on client terminals connected to an electric power management server, and thus does not support power management of shared terminals which are not client terminals. In addition, if the power to a shared terminal which is used by a user of a client terminal performing data communication over a network is turned off for power conservation due to not having been used for a while, then when the shared terminal is attempted to be used over the network thereafter, the shared terminal is unable to be used. Furthermore, since the shared terminal is not always present near a user who attempts to use it over the network, it is often troublesome for the user to turn on the power to the shared terminal.

In view of such circumstances, a first object of the present invention is therefore to provide a power management system, a power management apparatus, a program, and a power management method that perform power management of terminal apparatuses connected to a network, while ensuring the convenience of users who use the network.

In addition, in the electric power control method of the above-described Patent Literature 1, in order to perform electric power control of terminal apparatuses, it is premised that the setting for performing electric power control is performed in advance on the terminal apparatuses and a server apparatus. Thus, when the number of apparatuses on the network or the communication association between apparatuses has been changed, there is a need to newly set an apparatus connection state. However, when a network is actually used, there is a possibility that due to, for example, the installation of a new apparatus or the removal of an apparatus, the connection state of terminal apparatuses on the network may change. It is cumbersome to perform the setting for electric power control each time the connection state is changed and thus it is not convenient for users.

Hence, there is a demand for techniques for editing setting information required for terminal control by automatically obtaining terminal connection states in accordance with the states of terminals connected to a network.

A second object of the present invention is therefore to provide an information processing apparatus, a power management apparatus, a network management apparatus, a program, and an information processing method in which user convenience is improved by automatically updating terminal connection information according to the states of terminals connected to a network.

### Solution to Problem

A power management system according to a first aspect of the present invention is a power management system that manages power states of apparatuses and includes: one or a plurality of first apparatuses; one or a plurality of second apparatuses; and a management apparatus, and the management apparatus holds correspondence information in which one or a plurality of specific first apparatuses among the one or plurality of first apparatuses are associated with one or a plurality of specific second apparatuses among the one or plurality of second apparatuses, the one or plurality of specific second apparatuses performing data communication with the specific first apparatuses, and obtains information about power states of the specific first apparatuses and controls power states of the specific second apparatuses based on the information.

According to the power management system according to the first aspect, one or a plurality of specific first apparatuses and one or a plurality of specific second apparatuses which are associated with each other in correspondence information among one or a plurality of first apparatuses and one or a plurality of second apparatuses are set. Then, information about the power states of the specific first apparatuses is obtained, and based on the settings in the correspondence information and the information about the power states of the specific first apparatuses, the power states of the specific second apparatuses can be controlled. Therefore, power management can be performed in which, for example, when, with one or a plurality of first apparatuses and one or a plurality of second apparatuses being present, the power states of all specific first apparatuses are off, the power states of specific second apparatuses are set to off. Thus, power management considering convenience of users of the first apparatuses can be performed, such as setting the power states of only the specific second apparatuses that do not have data communication from their associated specific first apparatuses to off.

A power management system according to a second aspect of the present invention is such that in the power management system according to the first aspect, in particular, when the management apparatus obtains information indicating that a power state of at least one of the specific first apparatuses is on, the management apparatus sets the power states of the specific second apparatuses to on.

According to the power management system according to the second aspect, if the power state of at least one specific first apparatus among one or a plurality of first apparatuses is on, then power management of one or a plurality of specific second apparatuses is performed to set their power states to on. Therefore, the power state of a second apparatus which is a destination with which a user of a specific first apparatus performs data communication is on when the specific first apparatus is used, enabling the user of the specific first apparatus to perform data communication with the specific second apparatus. In addition, even if the power state of the specific second apparatus is off, the power to the specific second apparatus is turned on only by turning on the power to the specific first apparatus. Thus, without the need to separately operate the power to the specific second apparatus, a user who attempts to use the specific first apparatus can perform data communication with the specific second apparatus.

A power management system according to a third aspect of the present invention is such that in the power management system according to the first aspect, in particular, when the management apparatus obtains information indicating that the power states of all of the specific first apparatuses are off, the management apparatus sets the power states of the specific second apparatuses to off.

According to the power management system according to the third aspect, if the power states of all specific first apparatuses among one or a plurality of first apparatuses are off, then power management is performed on one or a plurality of specific second apparatuses and thus their power states can be set to off. Therefore, when a specific first apparatus that is associated as having data communication with a specific second apparatus in correspondence information is not used, data communication is not going to be performed on the specific second apparatus. Thus, power management that reduces power consumption can be performed by setting the power state of the specific second apparatus to off. In addition, the power states of specific second apparatuses are set to off without users performing an operation, when the power states of all specific first apparatuses having a communication relationship with the specific second apparatuses are set to off. Accordingly, forgetting to turn off the power to the specific second apparatuses is avoided, enabling the prevention of wasted power consumption caused by forgetting to turn off the power to shared terminals.

A power management system according to a fourth aspect of the present invention is such that in the power management system according to any one of the first to third aspects, in particular, the system further includes a control apparatus that controls the power states of the specific second apparatuses, and the management apparatus that transmits a predetermined signal to the control apparatus and thereby allows the control apparatus to control the power states of the specific second apparatuses.

According to the power management system according to the fourth aspect, the control apparatus controls the power states of specific second apparatuses by receiving a predetermined signal transmitted from the management apparatus. By this, even if the management apparatus and the control apparatus are located far away from each other, the power states of the specific second apparatuses can be controlled by performing communication using a predetermined signal. Therefore, the control apparatus can be placed at a location which is away from the management apparatus and where the specific second apparatuses are easily controlled, enabling the power state control performed by the control apparatus to be facilitated.

A power management system according to a fifth aspect of the present invention is such that in the power management system according to any one of the first to third aspects, in particular, the system further includes a detection apparatus that detects power states of the specific first apparatuses, and the management apparatus obtains information about the power states of the specific first apparatuses from the detection apparatus.

According to the power management system according to the fifth aspect, by the detection apparatus detecting power states of specific first apparatuses, information about the power states of the specific first apparatuses can be obtained, enabling the power states of specific second apparatuses to be controlled based on the information. Thus, by using the power management system according to the fifth aspect, power management can be performed, such as controlling the power states of specific second apparatuses based on the power states of specific first apparatuses, thereby reducing power consumption.

A power management system according to a sixth aspect of the present invention is such that in the power management system according to any one of the first to third aspects, in particular, the system further includes: a detection apparatus that detects power states of the specific first apparatuses; and a control apparatus that controls the power states of the specific second apparatuses, and the management apparatus obtains information about the power states of the specific first apparatuses from the detection apparatus, the management apparatus transmits a predetermined signal to the control apparatus and thereby allows the control apparatus to control the power states of the specific second apparatuses, and the detection apparatus and the control apparatus are housed in a common casing.

According to the power management system according to the sixth aspect, a detection apparatus that detects power states of specific first apparatuses and a control apparatus that controls the power states of specific second apparatuses are housed in a common casing, and thus, detection of the power states of the specific first apparatuses and control of the power states of the specific second apparatuses can be performed in one casing. Therefore, by connecting one or both of a first apparatus and a second apparatus to the casing, power management of these apparatuses can be performed using a predetermined signal from the management apparatus. In addition, since both detection of the power states of specific first apparatuses and control of the power states of specific second apparatuses can be performed in one casing, the hardware configuration of the system can be simplified.

A power management system according to a seventh aspect of the present invention is such that in the power management system according to the fourth or sixth aspect, in particular, when the management apparatus sets the power states of the specific second apparatuses to on, the predetermined signal transmitted to the control apparatus is a WOL (Wake On LAN) power control instruction.

According to the power management system according to the seventh aspect, when the power states of specific second apparatuses are set to on, transmission of a WOL (Wake On LAN) power control instruction is performed. Thus, by using a WOL power control instruction, the power states of the specific second apparatuses can be remotely, easily, and securely switched from off to on.

A power management system according to an eighth aspect of the present invention is such that in the power management system according to the fifth or sixth aspect, in particular, the management apparatus obtains the information about the power states of the specific first apparatuses from the detection apparatus by power-line communication.

According to the power management system according to the eighth aspect, information about the power states of specific first apparatuses which is obtained by the detection apparatus is transmitted to the management apparatus by power-line communication. Therefore, by using the power management system according to the eighth aspect, a power management system can be provided in which since an existing power line is used for communication, the detection apparatus and the management apparatus do not need to be connected to each other by a dedicated communication line and thus costs and efforts for installation of a new communication line are not incurred.

A power management system according to a ninth aspect of the present invention is such that in the power management system according to the fifth or sixth aspect, in particular, the management apparatus obtains the information about the power states of the specific first apparatuses from the detection apparatus by wireless communication.

According to the power management system according to the ninth aspect, information about the power states of specific first apparatuses which is obtained by the detection apparatus is transmitted to the management apparatus by wireless communication. Therefore, by using the power management system according to the ninth aspect, a power management system can be provided in which the detection apparatus and the management apparatus do not need to be connected to each other by a communication line and thus costs and efforts for installation of a communication line are not incurred.

A power management system according to a tenth aspect of the present invention is such that in the power management system according to any one of the fourth, sixth, and seventh aspects, in particular, the management apparatus transmits the predetermined signal to the control apparatus by power-line communication.

According to the power management system according to the tenth aspect, when the management apparatus transmits a predetermined signal to the control apparatus, the signal is transmitted by power-line communication. Therefore, by using the power management system according to the tenth aspect, a power management system can be provided in which since an existing power line is used for communication, the management apparatus and the control apparatus do not need to be connected to each other by a dedicated communication line and thus costs and efforts for installation of a new communication line are not incurred.

A power management system according to an eleventh aspect of the present invention is such that in the power management system according to any one of the fourth, sixth, and seventh aspects, in particular, the management apparatus transmits the predetermined signal to the control apparatus by wireless communication.

According to the power management system according to the eleventh aspect, when the management apparatus transmits a predetermined signal to the control apparatus, the signal is transmitted by wireless communication. Therefore, by using the power management system according to the eleventh aspect, a power management system can be provided in which the management apparatus and the control apparatus do not need to be connected to each other by a dedicated communication line and thus costs and efforts for installation of wiring for communication are not incurred.

A power management apparatus according to a twelfth aspect of the present invention is a power management apparatus that manages power states of apparatuses and includes: holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and control means for obtaining information about power states of the specific first apparatuses and controlling power states of the specific second apparatuses based on the information.

According to the power management apparatus according to the twelfth aspect, one or a plurality of specific first apparatuses and one or a plurality of specific second apparatuses which are associated with each other in correspondence information held by the holding means among one or a plurality of first apparatuses and one or a plurality of second apparatuses are set. Then, information about the power states of the specific first apparatuses is obtained, and based on the settings in the correspondence information and the information about the power states of the specific first apparatuses, the power states of the specific second apparatuses can be controlled by the control means. Therefore, power management can be performed in which, for example, when, with one or a plurality of first apparatuses and one or a plurality of second apparatuses being present, the power states of all specific first apparatuses are off, the power states of specific second apparatuses are set to off. Thus, power management can be performed that manages the power to only the specific second apparatuses that do not have data communication from their associated specific first apparatuses and that considers convenience of users of the first apparatuses.

A program according to a thirteenth aspect of the present invention causes a computer mounted on a power management apparatus that manages power states of apparatuses to function as: holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and control means for obtaining information about power states of the specific first apparatuses and controlling power states of the specific second apparatuses based on the information.

According to the program according to the thirteenth aspect, one or a plurality of specific first apparatuses and one or a plurality of specific second apparatuses which are associated with each other in correspondence information held by the holding means among one or a plurality of first apparatuses and one or a plurality of second apparatuses are set. Then, information about the power states of the specific first apparatuses is obtained, and based on the settings in the correspondence information and the information about the power states of the specific first apparatuses, the power states of the specific second apparatuses can be controlled by the control means. Therefore, power management can be performed in which, for example, when, with one or a plurality of first apparatuses and one or a plurality of second apparatuses being present, the power states of all specific first apparatuses are off, the power states of specific second apparatuses are set to off. Thus, power management considering convenience of users of the first apparatuses can be performed, such as setting the power states of only the specific second apparatuses that do not have data communication from their associated specific first apparatuses to off.

A power management method according to a fourteenth aspect of the present invention is a power management method for managing power states of apparatuses and includes: a step (A) of holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and a step (B) of obtaining information about power states of the specific first apparatuses and controlling power states of the specific second apparatuses based on the information.

According to the power management method according to the fourteenth aspect, based on correspondence information in which specific first apparatuses are associated with specific second apparatuses which is held in the step (A) and information about the power states of the specific first apparatuses which is obtained in the step (B), control of the power states of the specific second apparatuses can be performed. Therefore, power management can be performed in which, for example, when, with one or a plurality of first apparatuses and one or a plurality of second apparatuses being present, the power states of all specific first apparatuses are off, the power states of specific second apparatuses are set to off. Thus, power management considering convenience of users of the first apparatuses can be performed, such as setting the power states of only the specific second apparatuses that do not have data communication from their associated specific first apparatuses to off.

An information processing apparatus according to a fifteenth aspect of the present invention is an information processing apparatus that specifies a communication relationship between one or a plurality of first apparatuses and one or a plurality of second apparatuses, and includes: observing means for observing communication conditions between the first apparatuses and the second apparatuses; and editing means for editing, based on a result of the observation by the observing means, correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.

As used herein, the editing of correspondence information performed by the editing means includes not only a change to correspondence information but also creation and deletion of correspondence information.

According to the information processing apparatus according to the fifteenth aspect, communication conditions between the first apparatuses and the second apparatuses are observed by the observing means and based on a result of the observation, the editing means can edit correspondence information in which specific first apparatuses are associated with specific second apparatuses having a communication relationship with the specific first apparatuses. Since the correspondence information is edited in accordance with the conditions of communication performed by the specific first apparatuses and the specific second apparatuses, even if the communication conditions of the specific first apparatuses and the specific second apparatuses have been changed, the correspondence information is automatically changed according thereto. Therefore, by using the correspondence information, even if communication conditions have been changed when performing, for example, power management control or network management control, setting changes by users are not required and thus convenience for the users can be improved.

An information processing apparatus according to a sixteenth aspect of the present invention is such that in the information processing apparatus according to the fifteenth aspect, in particular, the observing means has detecting means for detecting communication packets communicated between the first apparatuses and the second apparatuses, and the editing means edits the correspondence information based on a number of communication packets detected by the detecting means during a unit of time.

According to the information processing apparatus according to the sixteenth aspect, the detecting means detects communication packets communicated between the first apparatuses and the second apparatuses and the editing means edits correspondence information based on the number of communication packets detected by the detecting means during a unit of time. Thus, the information processing apparatus according to the sixteenth aspect can accurately identify a second apparatus having a communication relationship with a first apparatus by, for example, comparing the detected number of communication packets with a predetermined threshold value.

An information processing apparatus according to a seventeenth aspect of the present invention is such that in the information processing apparatus according to the fifteenth aspect, in particular, the observing means has detecting means for detecting communication packets communicated between the first apparatuses and the second apparatuses, and the editing means edits the correspondence information based on a sum total of values each obtained by multiplying each of numbers of communication packets detected by the detecting means during a plurality of units of time, by a weighting value associated with each unit of time.

According to the information processing apparatus according to the seventeenth aspect, when the editing means edits correspondence information, the editing means performs editing based on a sum total of values each obtained by multiplying each of the numbers of communication packets detected by the detecting means during a plurality of units of time, by a weighting value associated with each unit of time. Therefore, editing of correspondence information can be performed taking into account not only the number of current communication packets but also how many communication packets have been communicated in the past. Furthermore, by using a value obtained by multiplying by a weighting value associated with each unit of time, editing of correspondence information in which the degree of reference to the amount of communication by the elapsed time from communication is changed can be performed, such as editing correspondence information where importance is placed on the past communication or editing correspondence information not taking into account the past communication.

An information processing apparatus according to an eighteenth aspect of the present invention is such that in the information processing apparatus according to the sixteenth or seventeenth aspect, in particular, the editing means identifies a first apparatus and a second apparatus based on MAC (Media Access Control) addresses contained in a packet header of a communication packet detected by the detecting means, the first and second apparatuses being a source and a destination of the communication packet, respectively.

According to the information processing apparatus according to the eighteenth aspect, the editing means identifies, based on MAC addresses contained in a packet header of a detected communication packet, a first apparatus which is a source of the communication packet and a second apparatus which is a destination of the communication packet. Therefore, even when a plurality of terminals perform communication with each other, since a MAC address varies from terminal hardware to terminal hardware, a first apparatus and a second apparatus can be accurately identified.

An information processing apparatus according to a nineteenth aspect of the present invention is such that in the information processing apparatus according to the sixteenth or seventeenth aspect, in particular, the editing means identifies a first apparatus and a second apparatus based on IP (Internet Protocol) addresses contained in a packet header of a communication packet detected by the detecting means, the first and second apparatuses being a source and a destination of the communication packet, respectively.

According to the information processing apparatus according to the nineteenth aspect, the editing means identifies, based on IP addresses contained in a packet header of a detected communication packet, a first apparatus which is a source of the communication packet and a second apparatus which is a destination of the communication packet. By using IP addresses, even when a first apparatus and a second apparatus which perform communication belong to different hosts forming a network, terminals can be identified. Thus, by obtaining IP addresses of a destination terminal and a source terminal, the first apparatus and the second apparatus can be appropriately identified.

A power management apparatus according to a twentieth aspect of the present invention is a power management apparatus that manages power states of apparatuses and includes: holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; control means for obtaining information about power states of the specific first apparatuses and controlling power states of the specific second apparatuses based on the information; observing means for observing communication conditions between the first apparatuses and the second apparatuses; and editing means for editing the correspondence information based on a result of the observation by the observing means.

As used herein, the editing of correspondence information performed by the editing means includes not only a change to correspondence information but also creation and deletion of correspondence information.

According to the power management apparatus according to the twentieth aspect, the observing means observes communication conditions between the first apparatuses and the second apparatuses, and the editing means edits, based on a result of the observation by the observing means, correspondence information in which specific first apparatuses are associated with specific second apparatuses that perform data communication with the specific first apparatuses. Furthermore, the holding means holds the correspondence information and the control means controls the power states of the specific second apparatuses based on the correspondence information held by the holding means and obtained information about the power states of the first apparatuses. Therefore, power management control can be performed in which since power control is performed based on correspondence information which is edited in accordance with the conditions of communication performed by the specific first apparatuses and the specific second apparatuses, even if the connection conditions between the first apparatuses and the second apparatuses have been changed, setting changes by users are not required and thus convenience for the users is improved.

A network management apparatus according to a twenty-first aspect of the present invention is a network management apparatus that manages communication on a network and includes: holding means for holding correspondence information in which a first apparatus and a second apparatus among a plurality of apparatuses connected to the network are associated with each other, and specifying information specifying whether to allow communication between the plurality of apparatuses, the first apparatus being a source of data and the second apparatus being a destination of the data; control means for controlling a communication state between the first apparatus and the second apparatus based on the correspondence information and the specifying information; observing means for observing communication conditions between the plurality of apparatuses; and editing means for editing the correspondence information based on a result of the observation by the observing means.

As used herein, the editing of correspondence information performed by the editing means includes not only a change to correspondence information but also creation and deletion of correspondence information.

According to the network management apparatus according to the twenty-first aspect, the observing means observes communication conditions between a plurality of apparatuses and the editing means edits, based on a result of the observation by the observing means, correspondence information in which a first apparatus and a second apparatus that perform data communication are associated with each other. By comparing the correspondence information with specifying information specifying whether to allow communication between the plurality of apparatuses, a determination as to whether communication has been performed between apparatuses that are not allowed in the specifications can be made. Thus, network management can be performed in which, for example, if there is communication not allowed in the specifications, then limitations on communication between apparatuses having performed the communication are imposed by the control means.

A program according to a twenty-second aspect of the present invention causes a computer mounted on an information processing apparatus that specifies a communication relationship between one or a plurality of first apparatuses and one or a plurality of second apparatuses to function as: observing means for observing communication conditions between the first apparatuses and the second apparatuses, and editing means for editing, based on a result of the observation by the observing means, correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.

As used herein, the editing of correspondence information performed by the editing means includes not only a change to correspondence information but also creation and deletion of correspondence information.

According to the program according to the twenty-second aspect, by causing a computer mounted on an information processing apparatus that specifies a communication relationship between one or a plurality of first apparatuses and one or a plurality of second apparatuses to execute the program, communication conditions between the first apparatuses and the second apparatuses are observed and based on a result of the observation, correspondence information in which specific first apparatuses and specific second apparatuses that have a communication relationship with each other among the first apparatuses and the second apparatuses are associated with each other can be edited. Since the correspondence information is edited in accordance with the conditions of communication performed by the specific first apparatuses and the specific second apparatuses, even when the communication conditions of the specific first apparatuses and the specific second apparatuses have been changed, the correspondence information is also changed according thereto. Therefore, by using the correspondence information, even if communication conditions have been changed when performing, for example, power management control or network management control, setting changes by users are not required and thus convenience for the users can be improved.

An information processing method according to a twenty-third aspect of the present invention is an information processing method for specifying a communication relationship between one or a plurality of first apparatuses and one or a plurality of second apparatuses, and includes: a step (A) of observing communication conditions between the first apparatuses and the second apparatuses; and a step (B) of editing, based on a result of the observation in the step (A), correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.

The editing of correspondence information as used in the step (B) includes not only a change to correspondence information but also creation and deletion of correspondence information.

According to the information processing method according to the twenty-third aspect, communication conditions between the first apparatuses and the second apparatuses are observed and based on a result of the observation, correspondence information in which specific first apparatuses and specific second apparatuses that have a communication relationship with each other are associated with each other is edited. Since the correspondence information is edited in accordance with the conditions of communication performed by the specific first apparatuses and the specific second apparatuses, even if the communication conditions of the specific first apparatuses and the specific second apparatuses have been changed, the correspondence information is also changed according thereto. Therefore, by using the correspondence information, even if communication conditions have been changed when performing, for example, power management control or network management control, setting changes by users are not required and thus convenience for the users can be improved.

### ADVANTAGEOUS EFFECTS OF INVENTION

According the present invention, power management considering user convenience can be performed.

In addition, according to the present invention, setting changes by users are not required and thus convenience for the users can be improved.

### BRIEF DESCRIPTION OF DRAWINGS

FIG. 1 is a block diagram schematically showing a configuration of a power management system according to a first embodiment of the present invention.

FIG. 2 is a flowchart showing power-on control operations.

FIG. 3 is a diagram showing an example of a power state table.

FIG. 4 is a diagram showing an example of a correspondence information table.

FIG. 5 is a diagram showing an example of a terminal information table.

FIG. 6 is a flowchart showing power-off control operations.

FIG. 7 shows an example of a block diagram schematically showing a configuration for the case in which a power management apparatus is a computer.

FIG. 8 is a block diagram schematically showing a configuration of a power management system including a router.

FIG. 9 is a diagram schematically showing an example of installation of a power strip in a power management system according to a second variant of the first embodiment.

FIG. 10 is a diagram schematically showing a configuration of a power strip capable of performing power-line communication.

FIG. 11 is a diagram schematically showing a configuration of a power strip capable of performing wireless communication.

FIG. 12 is a block diagram schematically showing a configuration of an information processing apparatus according to a second embodiment of the present invention.

FIG. 13 is a flowchart showing operations in a correspondence information editing process.

FIG. 14 shows a mathematical formula for calculating an index value.

FIG. 15 shows mathematical formulae for calculating index values for when the degree of past reference is 1 to 3.

FIG. 16 is a block diagram schematically showing a configuration of a power management system including an information processing apparatus.

FIG. 17 shows an example of the amounts of communication detected by the information processing apparatus.

FIG. 18 shows an example of calculation of index values for different setting conditions.

FIG. 19 is an example of a correspondence information table.

FIG. 20 is a flowchart showing the power-on control operations of a power management system according to a first variant of the second embodiment.

FIG. 21 shows an example of a power state table of the power management system according to the first variant of the second embodiment.

FIG. 22 shows an example of a terminal information table of the power management system according to the first variant of the second embodiment.

FIG. 23 is a flowchart showing the power-off control operations of the power management system according to the first variant of the second embodiment.

FIG. 24 is an example of a power state table of the power management system according to the first variant of the second embodiment.

FIG. 25 is a block diagram schematically showing a configuration of a network management system including an information processing apparatus.

### DESCRIPTION OF EMBODIMENTS

Embodiments of the present invention will be described below using the drawings. Note that those components denoted by the same reference signs in different drawings indicate the same or corresponding components.

### First Embodiment

A power management system 1 according to a first embodiment of the present invention is to perform power management of a shared terminal connected to a network, based on the power state of an end terminal that uses the shared terminal over the network.

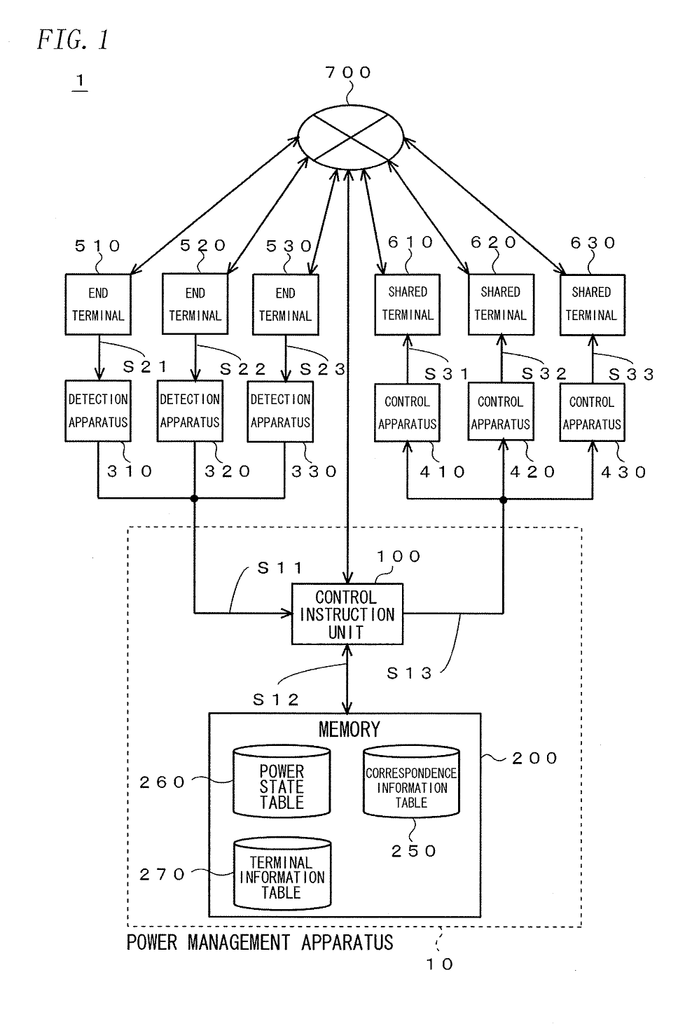

FIG. 1 is a block diagram schematically showing a configuration of the power management system 1 according to the first embodiment of the present invention. As shown in FIG. 1, the power management system 1 includes a power management apparatus 10 which is a management apparatus; end terminals 510, 520, and 530 which are first apparatuses; shared terminals 610, 620, and 630 which are second apparatuses; detection apparatuses 310, 320, and 330; control apparatuses 410, 420, and 430; and a network 700. Furthermore, the power management apparatus 10 includes a control instruction unit 100 and a memory 200. The memory 200 holds a correspondence information table 250 having stored therein correspondence information; a power state table 260 having stored therein the power states of the respective terminals; and a terminal information table 270 having stored therein the terminal information of the respective terminals. Note that the end terminals in the embodiment of the present invention include, for example, terminals that are operated by users, such as personal computers and televisions, and the shared terminals include, for example, terminals that are shared among the users, such as shared servers, NASs (Network Attached Storages), hubs, switches, routers, STBs (Set Top Boxes), and DVD recorders/players.

Next, the connection relationship between the components in the power management system 1 will be described. An input of the detection apparatus 310 is connected to an output of the end terminal 510. An input of the detection apparatus 320 is connected to an output of the end terminal 520. An input of the detection apparatus 330 is connected to an output of the end terminal 530. Inputs of the control instruction unit 100 are connected to an output of the memory 200, an output of the detection apparatus 310, an output of the detection apparatus 320, and an output of the detection apparatus 330. An input of the control apparatus 410 is connected to an output of the control instruction unit 100. An input of the control apparatus 420 is connected to the output of the control instruction unit 100. An input of the control apparatus 430 is connected to the output of the control instruction unit 100. An input of the shared terminal 610 is connected to an output of the control apparatus 410. An input of the shared terminal 620 is connected to an output of the control apparatus 420. An input of the shared terminal 630 is connected to an output of the control apparatus 430. In addition, the control instruction unit 100, each end terminal, and each shared terminal are connected to the network 700 and can perform communication over the network 700.

Next, the operation of the power management system 1 according to the embodiment of the present invention will be described. The power management system 1 starts power management control by detecting a change in the power state of an end terminal to which a detection apparatus is connected. Power management control performed by the power management system 1 according to the embodiment of the present invention includes power-on control performed when the power to an end terminal is turned on from off; and power-off control performed when the power to the end terminal is turned off from on.

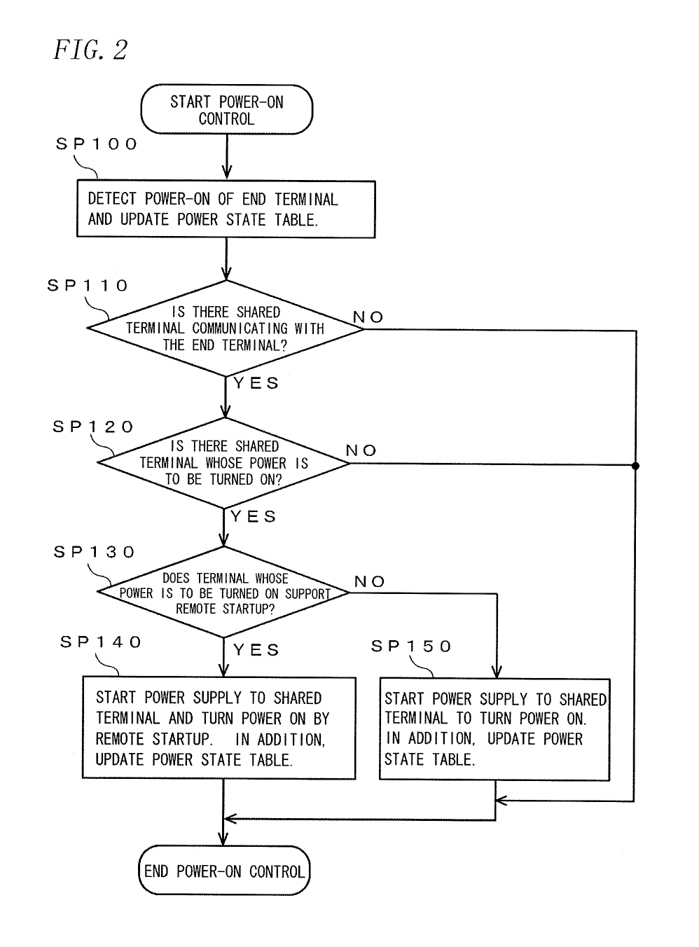

FIG. 2 is a flowchart showing power-on control operations performed by the power management system 1 when the power to an end terminal is turned on from off. Description of the power-on control operations will be made using FIG. 2.

When there is an end terminal whose power has been turned on from off among the end terminals, first, in step SP100, a detection apparatus connected to the end terminal detects a change in the power state of the end terminal. For a method for performing this detection, the detection apparatus may receive a power-on signal from the end terminal, or the detection apparatus may monitor the power consumption of the end terminal and detect power-on by the event that the power consumption of the end terminal has reached a predetermined threshold value or more.

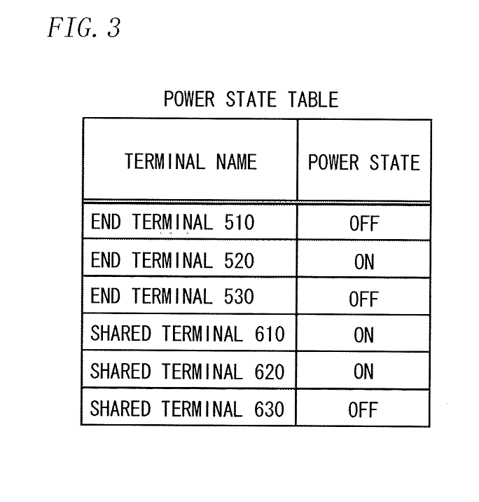

Then, a detection result detected by the detection apparatus is sent to the control instruction unit 100 as a detection result signal S11. The control instruction unit 100 having the detection result signal S11 inputted thereto accesses the memory 200 to rewrite the item for the power state of the end terminal stored in the power state table 260 to a power state conforming to the detection result. FIG. 3 shows an example of the power state table 260. As shown in FIG. 3, the power state table 260 stores whether the power state of each terminal performing communication over the network 700 is currently on or off. The information about the power states in the power state table 260 is held such that when the power states of the respective terminals have been changed, the changes thereof in power state are reflected one by one.

Then, in step SP110, the control instruction unit 100 identifies a target shared terminal on which power-on control is performed, and determines whether the target shared terminal is present. Specifically, the control instruction unit 100 reads correspondence information from the correspondence information table 250 held in the memory 200. The control instruction unit 100 further identifies, based on the correspondence information, a shared terminal having a communication relationship with the end terminal whose power state is detected to have been changed from off to on in step SP100, and determines whether the shared terminal is present. At this time, if there is a shared terminal having a communication relationship with the terminal whose power has been turned on (i.e., if the determination in step SP110 is “YES”), then the control instruction unit 100 performs an operation in step SP120 to be described later. On the other hand, if there is no shared terminal having a communication relationship with the terminal whose power has been turned on (i.e., if the determination in step SP110 is “NO”), then the power management system 1 ends the power-on control.

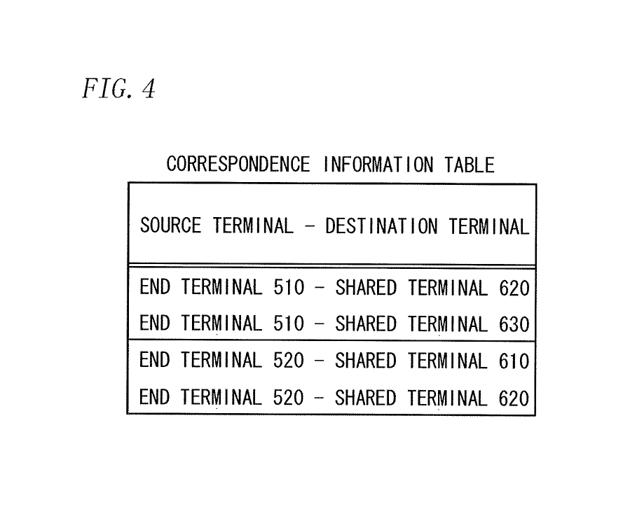

The correspondence information held in the correspondence information table 250 indicates which terminals have a communication relationship with each other among the end terminals and the shared terminals which are connected to each other over the network 700. FIG. 4 shows an example of the correspondence information table 250. As shown in FIG. 4, the correspondence information specifies the correspondence between terminals having a communication relationship over the network 700. The correspondence information may be set in advance in the correspondence information table 250 or may be set by an external input. Note that although FIG. 4 shows an example of correspondence information in which the correspondence between terminals having a communication relationship is separated between a communication source and a communication destination, in the present invention, the correspondence information may be information in which the correspondence is not separated between a source and a destination, as long as the correspondence is one between terminals having a communication relationship.

Then, in step SP120, the control instruction unit 100 checks the power state of the shared terminal having been determined to have a communication relationship with the end terminal based on the correspondence information in step SP110, by referring to the power state table 260 held in the memory 200. Then, the control instruction unit 100 determines whether there is a shared terminal which has a communication relationship with the end terminal whose power has been turned on from off, and whose power state is off despite the fact that due to the power state of the end terminal having been changed to on, the possibility of the shared terminal performing data communication over the network 700 arises and thus the power to the shared terminal is to be turned on.

Here, if there is a shared terminal whose power is to be turned on but whose power state is off (i.e., if the determination in step SP120 is “YES”), then the control instruction unit 100 performs an operation in step SP130 which will be described later. At this time, if there are a plurality of shared terminals whose power is to be turned on, then power-on control at and after step SP130 is performed on all of the respective terminals. If, as a result of referring to the power state table 260, the power states of all of the terminals whose power is to be turned on are already on (i.e., if the determination in step SP120 is “NO”), then the power management system 1 ends the power-on control.

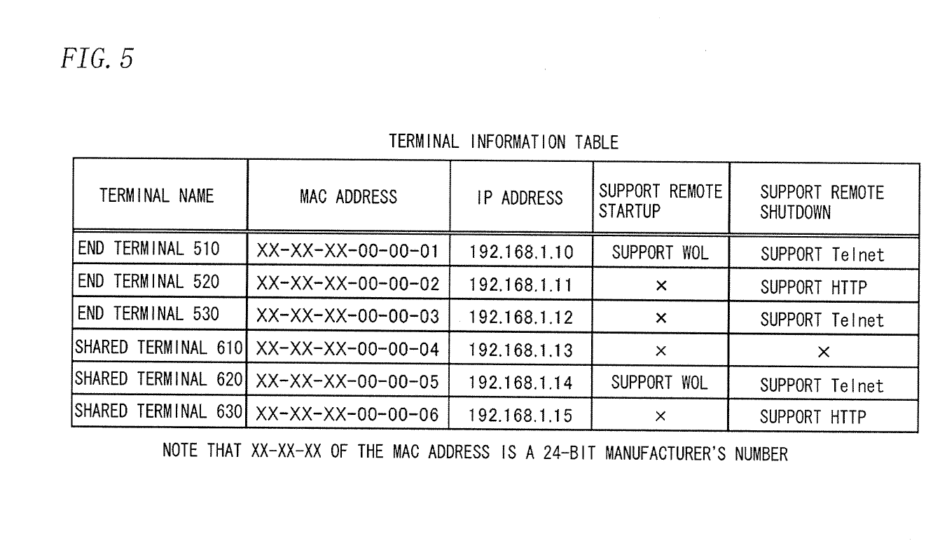

Then, in step SP130, the control instruction unit 100 reads, from the terminal information table 270 held in the memory 200, terminal information of the shared terminal determined in step SP120 that its power is to be turned on, to determine whether the shared terminal supports remote startup. FIG. 5 shows an example of the terminal information table 270. As shown in FIG. 5, the terminal information table 270 stores terminal information such as the addresses of each terminal and whether each terminal supports remote startup and remote shutdown. The terminal information is set in advance when performing power management using the power management system 1, but when the terminal information has been changed in the middle of power management, the terminal information in the terminal information table 270 is to be rewritten and updated.

Here, if it is determined by referring to the terminal information that the shared terminal whose power is to be turned on is a terminal supporting remote startup (i.e., if the determination in step SP130 is “YES”), then the control instruction unit 100 performs an operation in step SP140 which will be described later. On the other hand, if the shared terminal whose power is to be turned on is not a terminal supporting remote startup (i.e., if the determination in step SP130 is “NO”), then the control instruction unit 100 performs an operation in step SP150 which will be described later.

Then, in step SP140, the control instruction unit 100 transmits to a control apparatus connected to the shared terminal whose power is to be turned on, an instruction signal instructing to start power supply to the shared terminal. The control apparatus having received the instruction signal starts power supply to the shared terminal connected thereto. The control instruction unit 100 further transmits a power control instruction signal which is a predetermined signal, to the shared terminal over the network 700. The shared terminal having received the power control instruction signal performs remote startup in accordance with a power control instruction. Here, the power control instruction transmitted to the shared terminal may be a remote startup code called a magic packet specified by the WOL (Wake On LAN) function, or may be other power control instructions performing remote startup.

In addition, here, when the power to the shared terminal is turned on from off by remote startup, the control instruction unit 100 accesses the memory 200 to rewrite the corresponding item for the power state of the shared terminal in the power state table 260 from ‘off’ to ‘on’, and ends the power-on control.

Then, if the determination in step SP130 is “NO”, then in step SP150, the control instruction unit 100 transmits, as a predetermined signal, an instruction signal S13 instructing to turn on the power to the shared terminal, to the control apparatus connected to the shared terminal. The control apparatus having received the instruction signal S13 performs control to turn on the power to the shared terminal. Here, in the power-on control performed by the control apparatus, the power may be turned on by the control apparatus starting power supply to the shared terminal.

Furthermore, when the power state of the shared terminal is changed from off to on, the control instruction unit 100 accesses the memory 200 to rewrite the corresponding item for the power state of the shared terminal in the power state table 260 from ‘off’ to ‘on’, and ends the power-on control.

Here, the flow of power-on control operations will be specifically described using, as an example, the case in which the power to the end terminal 510 is turned on from off. When the power to the end terminal 510 is turned on from off, first, in step SP100, the detection apparatus 310 receives a power-on signal S21 notifying that the power to the end terminal 510 has been turned on, and thereby detects that the power to the end terminal 510 has been turned on. Then, the detection apparatus 310 outputs a detection result signal S11 to the control instruction unit 100. The control instruction unit 100 having received the detection result signal S11 accesses the memory 200 to rewrite the item for the power state of the ‘end terminal 510’ in the power state table 260 from ‘off’ to ‘on’.

Then, in step SP110, the control instruction unit 100 accesses the memory 200 to refer to the correspondence information table 250 to check which terminals are counterpart terminals that are specified to have a communication relationship with the end terminal 510 whose power is found to have been turned on by a detection result received from the detection apparatus 310. Here, assuming that the correspondence information table 250 in FIG. 4 is referred to, the counterpart terminals specified to have a communication relationship with the ‘end terminal 510’ are the ‘shared terminal 620’ and the ‘shared terminal 630’. Therefore, since there are shared terminals having a communication relationship with the end terminal whose power state is detected to have been changed from off to on, the determination in step SP110 is “YES” and thus processing proceeds to step SP120.

Then, in step SP120, the control instruction unit 100 accesses the memory 200 to refer to the power state table 260 to check the power states of the shared terminal 620 and the shared terminal 630 which have a communication relationship with the end terminal 510 whose power state is detected to have been changed from off to on. Assuming that the power state table 260 in FIG. 3 is referred to, the ‘end terminal 620’ is ‘on’ and the ‘end terminal 630’ is ‘off’. Therefore, the control instruction unit 100 identifies the shared terminal 630 whose power state is off, as a shared terminal whose power is to be turned on. Then, since there is a shared terminal whose power is to be turned on, the determination in step SP120 is “YES” and thus processing proceeds to step SP130.

Then, in step SP130, the control instruction unit 100 accesses the memory 200 to refer to the terminal information table 270 to determine whether the shared terminal 630 which is a terminal whose power is to be turned on supports remote startup. Here, assuming that the terminal information table 270 in FIG. 5 is referred to, since the ‘shared terminal 630’ ‘does not support remote startup’, the determination in step SP130 is “NO” and thus processing proceeds to step SP150.

Then, in step SP150, the control instruction unit 100 transmits an instruction signal S13 instructing to turn on the power to the shared terminal 630, to the control apparatus 430 connected to the shared terminal 630. The control apparatus 430 having received the instruction signal S13 performs power supply to the shared terminal 630 to turn on the power to the shared terminal 630. Furthermore, the control instruction unit 100 accesses the memory 200 to rewrite the item for the power state of the ‘shared terminal 630’ in the power state table 260 from ‘off’ to ‘on’, and ends the power-on control.

As described above, in power-on control of the power management system 1, by a detection apparatus detecting power-on of an end terminal, the power to a shared terminal which is a counterpart performing communication with the end terminal can be turned on. Accordingly, when the end terminal is being used, the power to the shared terminal which is a counterpart performing communication with the end terminal over the network 700 is turned on. Thus, a user of the end terminal can perform data communication with the shared terminal at any time when using the end terminal.

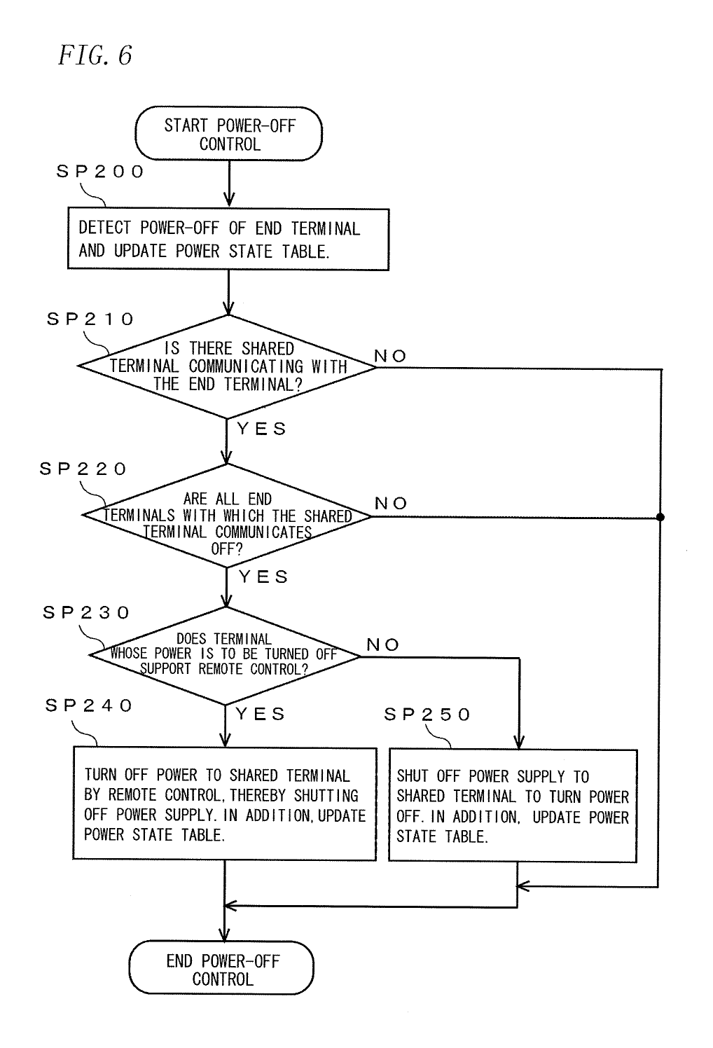

FIG. 6 is a flowchart showing power-off control operations performed by the power management system 1 when the power to an end terminal is turned off from on. Description of the power-off control operations will be made using FIG. 6.

When there is an end terminal whose power has been turned off from on among the end terminals, first, in step SP200, a detection apparatus connected to the end terminal detects a change in the power state of the end terminal. For a method for performing this detection, the detection apparatus may receive a power-off signal from the end terminal, or the detection apparatus may monitor the power consumption of the end terminal and detect power-off by the event that the power consumption of the end terminal has reached less than a predetermined threshold value.

Then, a detection result detected by the detection apparatus is sent to the control instruction unit 100 as a detection result signal S11. The control instruction unit 100 having the detection result signal S11 inputted thereto accesses the memory 200 to rewrite, based on the detection result, the power state of the terminal in the power state table 260 to a power state conforming to the detection result.

Then, in step SP210, the control instruction unit 100 determines whether there is a shared terminal with which the end terminal has a communication relationship. Specifically, the control instruction unit 100 reads correspondence information from the correspondence information table 250 held in the memory 200. The control instruction unit 100 further identifies, based on the correspondence information, a shared terminal having a communication relationship with the end terminal whose power state is detected to have been changed from on to off in step SP200, and determines whether the shared terminal is present.

At this time, if there is a shared terminal having a communication relationship with the terminal whose power has been turned off (i.e., if the determination in step SP210 is “YES”), then the control instruction unit 100 performs an operation in step SP220 which will be described later. Here, if there are a plurality of shared terminals having a communication relationship with the end terminal whose power state is detected to have been changed from on to off, then power-off control at and after step SP220 is performed on each of the plurality of shared terminals. If, on the other hand, there is no shared terminal having a communication relationship with the terminal whose power has been turned off (i.e., if the determination in step SP210 is “NO”), then the power management system 1 ends the power-off control.

Then, in step SP220, the control instruction unit 100 checks whether the shared terminal having a communication relationship with the end terminal whose power has been turned off has any other end terminal having a communication relationship therewith than the end terminal, by referring to the correspondence information table 250 held in the memory 200. The control instruction unit 100 further checks the power states of all of the end terminals having a communication relationship with the shared terminal having a communication relationship with the end terminal whose power has been turned off, by referring to the correspondence information table 250 and the power state table 260 which are held in the memory 200. Then, the control instruction unit 100 determines whether the power states of all of those end terminals are off. In power-off control performed by the power management system 1, when the power states of all of the end terminals having a communication relationship with a certain shared terminal are off, the power state of the shared terminal is set to off.

Here, if the power states of all of the corresponding end terminals are off (i.e., if the determination in step SP220 is “YES”), then the control instruction unit 100 performs an operation in step SP230 which will be described later. Further, if the power state of at least one of all of the corresponding end terminals is not off (i.e., if the determination in step SP220 is “NO”), then the power management system 1 ends the power-off control.

Then, in step SP230, the control instruction unit 100 reads terminal information of the shared terminal having a communication relationship with the terminal whose power has been turned off in step SP210, from the terminal information table 270 held in the memory 200 to determine whether the shared terminal supports remote control.

Here, if, as a result of referring to the terminal information, the shared terminal is a terminal supporting remote control (i.e., if the determination in step SP230 is “YES”), then the control instruction unit 100 performs an operation in step SP240 which will be described later. On the other hand, if the shared terminal is not a terminal supporting remote control (i.e., if the determination in step SP230 is “NO”), then the control instruction unit 100 performs an operation in step SP250 which will be described later.

Then, in step SP240, the control instruction unit 100 transmits, over the network 700, a power control instruction signal which is a predetermined signal to the shared terminal whose power is to be turned off because the power states of all of the end terminals having a communication relationship therewith are off. The shared terminal having received the power control instruction signal performs remote control in accordance with a power control instruction and thereby performs a terminal termination process. The remote control as used herein refers to remote control performed by logging in to a shared terminal using Telnet, HTTP, etc., and the termination process is to perform shutdown of the shared terminal by, for example, executing a shutdown command of the remote control.

Then, when the shared terminal is shut down by remote control, the control instruction unit 100 further transmits an instruction signal S13 instructing to shut off the power supply to the shared terminal, to a control apparatus connected to the shared terminal. The control apparatus having received the instruction signal S13 shuts off the power supply to the shared terminal connected thereto. Then, the control instruction unit 100 accesses the memory 200 to rewrite the corresponding item for the power state of the shared terminal in the power state table 260 from ‘on’ to ‘off’, and ends the power-off control.

If the determination in step SP230 is “NO”, then in step SP250, the control instruction unit 100 transmits, as a predetermined signal, an instruction signal S13 instructing to turn off the power to the shared terminal, to the control apparatus connected to the shared terminal. The control apparatus having received the instruction signal S13 performs control to turn off the power to the shared terminal. Here, in the power-off control performed by the control apparatus, the power may be turned off by the control apparatus shutting off the power supply to the shared terminal.

Furthermore, when the power state of the shared terminal is changed from on to off, the control instruction unit 100 accesses the memory 200 to rewrite the corresponding item for the power state of the shared terminal in the power state table 260 from ‘on’ to ‘off’, and ends the power-off control.

Here, the flow of power-off control operations will be specifically described using, as an example, the case in which the power to the end terminal 520 is turned off from on. When the power to the end terminal 520 is turned off from on, first, in step SP200, the detection apparatus 320 receives a power-off signal S22 notifying that the power to the end terminal 520 has been turned off, and thereby detects that the power to the end terminal 520 has been turned off. Then, the detection apparatus 320 outputs a detection result signal S11 to the control instruction unit 100. The control instruction unit 100 having received the detection result signal S11 accesses the memory 200 to rewrite the item for the power state of the ‘end terminal 520’ in the power state table 260 from ‘on’ to ‘off’.

Then, in step SP210, the control instruction unit 100 accesses the memory 200 to refer to the correspondence information table 250 to check counterpart terminals that are specified to have a communication relationship with the end terminal 520 whose power has been turned off. Here, assuming that the correspondence information table 250 in FIG. 4 is referred to, the counterpart terminals specified to have a communication relationship with the ‘end terminal 520’ are the ‘shared terminal 610’ and the ‘shared terminal 620’. Therefore, since there are shared terminals having a communication relationship with the end terminal whose power state is detected to have been changed from on to off, the determination in step SP210 is “YES” and thus processing proceeds to step SP220. Subsequent power-off control is performed on each of the shared terminal 610 and the shared terminal 620.

Then, in step SP220, the control instruction unit 100 checks whether each of the shared terminal 610 and the shared terminal 620 which are shared terminals having a communication relationship with the end terminal 520 whose power has been turned off, has any other end terminal having a communication relationship therewith than the end terminal 520, by referring to the correspondence information table 250 held in the memory 200. Referring to the correspondence information table 270 in FIG. 4, the shared terminal 610 performs communication only with the end terminal 520 and the shared terminal 620 has a communication relationship not only with the end terminal 520 but also with the end terminal 510.

Here, referring to the power state table 260 in FIG. 3, the power state of the ‘end terminal 520’ with which the shared terminal 610 has a communication relationship has been rewritten to ‘off’ in step SP200. Therefore, all of the end terminals with which the shared terminal 610 has a communication relationship are off and thus in the power-off control performed on the shared terminal 610, the determination in step SP220 is “YES” and thus processing proceeds to step SP230.

In addition, referring to the power state table 260 in FIG. 3, the power states of the ‘end terminal 510’ and the ‘end terminal 520’ with which the shared terminal 620 has a communication relationship are such that the ‘end terminal 510’ is ‘off’ and the ‘end terminal 520’ has been rewritten to ‘off’ in step SP200. Therefore, all of the end terminals with which the shared terminal 620 has a communication relationship are off and thus in the power-off control performed on the shared terminal 620, the determination in step SP220 is “YES” and thus processing proceeds to step SP230.

Then, in step SP230, the control instruction unit 100 accesses the memory 200 to refer to the terminal information table 270 to determine whether the shared terminal 610 and the shared terminal 620 which are terminals whose power is to be turned off support remote shutdown. Here, assuming that the terminal information table 270 in FIG. 5 is referred to, since the ‘shared terminal 610’ ‘does not support remote shutdown’, in the power-off control of the shared terminal 610, the determination in step SP230 is ‘NO’ and thus processing proceeds to step SP250. In addition, since the ‘shared terminal 620’ ‘supports Telnet’, in the power-off control of the shared terminal 620, the determination in step SP230 is ‘YES’ and thus processing proceeds to step SP240.

In the power-off control of the shared terminal 620, in step SP240, the control instruction unit 100 logs in via Telnet and transmits a Telnet standard power control instruction signal which is a predetermined signal to the shared terminal 620 over the network 700. The shared terminal 620 having received the power control instruction signal performs shutdown in accordance with a power control instruction. Furthermore, the control instruction unit 100 transmits an instruction signal instructing to shut off the power supply to the shared terminal 620, to the control apparatus 420. The control apparatus 420 having received the instruction signal shuts off the power supply to the shared terminal 620. Then, the control instruction unit 100 accesses the memory 200 to rewrite the item for the power state of the ‘shared terminal 620’ in the power state table 260 from ‘on’ to ‘off’, and ends the power off control.

In addition, in the power-off control of the shared terminal 610, in step SP250, the control instruction unit 100 transmits, as a predetermined signal, an instruction signal instructing to turn off the power to the shared terminal 610, to the control apparatus 410 connected to the shared terminal 610. The control apparatus 410 having received the instruction signal shuts off the power supply to the shared terminal 610, thereby turning off the power. Then, the control instruction unit 100 accesses the memory 200 to rewrite the item for the power state of the ‘shared terminal 610’ in the power state table 260 from ‘on’ to ‘off’, and ends the power-off control.

As described above, in the power management system 1, by power-off control, a detection apparatus detects power-off of an end terminal and when the power states of all end terminals having a communication relationship with a shared terminal which is a counterpart performing communication with the end terminal are off, the power to the shared terminal can be turned off. Therefore, by using the power management system 1, power consumption can be reduced by turning off the power to a shared terminal which is not going to be used because the power state of an end terminal performing communication with the shared terminal over the network 700 is off. In addition, since the power to the shared terminal with which communication from the end terminal is not going to be performed is automatically turned off, wasted power consumption caused by forgetting to turn off the power to the shared terminal can be prevented.

In the power management system 1, by performing the above-described power-on control and power-off control at all times which are performed by detecting changes in the power state of each end terminal, when the power to an end terminal is turned on, the power to a shared terminal that is specified to have a communication relationship with the end terminal and thus has a chance of being used can be turned on, and the power to a shared terminal having end terminals which are specified to have a communication relationship with the shared terminal and whose power states are all off can be turned off. Thus, according to the power management system 1 according to the embodiment of the present invention, power management can be performed in which when a user of an end terminal uses a shared terminal over the network 700, the power to the shared terminal is turned on, ensuring convenience for the user, and when there is no data communication from the end terminal, the power to the shared terminal is turned off, enabling power consumption saving.

Note that although description is made exemplifying the case of three end terminals and three shared terminals, the numbers of end terminals and shared terminals are not limited thereto. Note also that when a single terminal serves as both an end terminal and a shared terminal, too, by connecting a detection apparatus and a control apparatus to the terminal, the power management system 1 according to the embodiment of the present invention can perform power management.

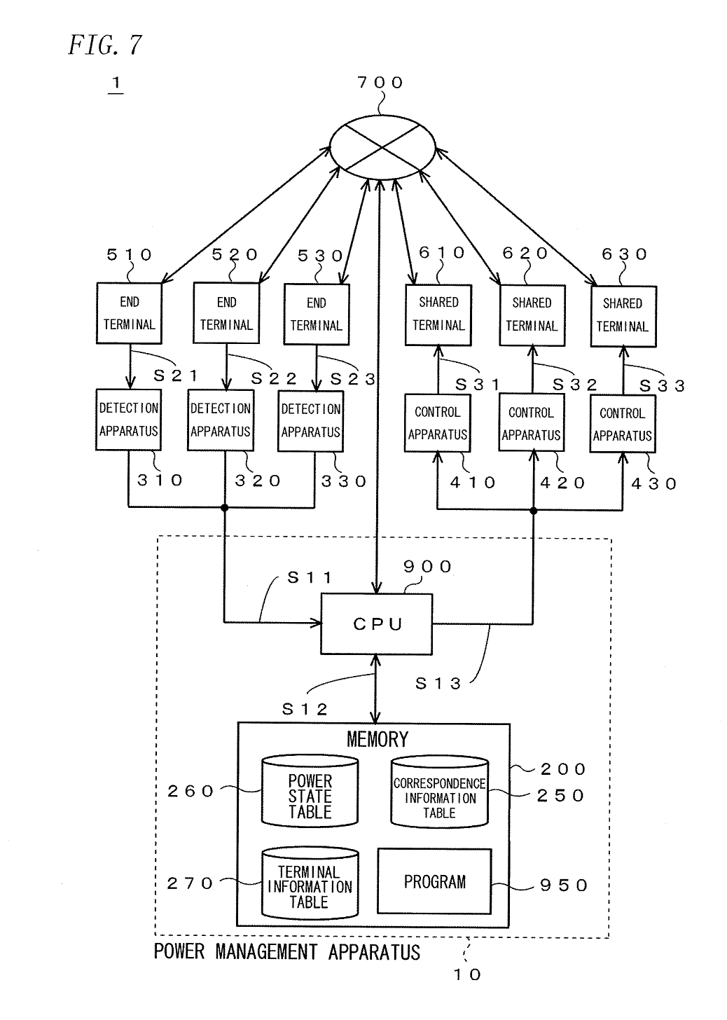

The power management apparatus 10 may be a general-purpose computer system. FIG. 7 shows an example of a schematic configuration for the case in which the power management apparatus 10 is a computer system. At this time, a power management function owned by the power management apparatus 10 is implemented by a CPU 900, which is included in the power management apparatus 10, executing a program 950 called from a memory (recording medium) 200.

### First Variant of the First Embodiment

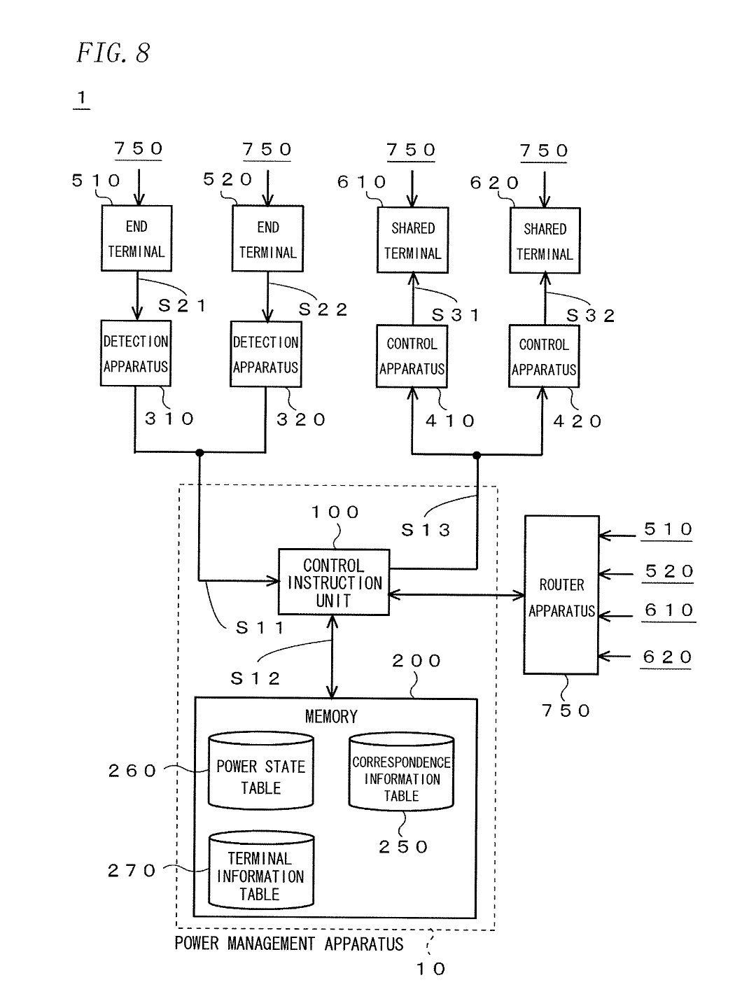

FIG. 8 is a block diagram schematically showing a configuration of a power management system 1 according to a first variant of the first embodiment. The power management system 1 according to the first variant of the first embodiment further includes a router apparatus 750. The router apparatus 750 is connected to each end terminal and each shared terminal on which power management is performed, thereby forming a local network where data communication between the terminals is performed.

By including the router apparatus 750, the power management system 1 can monitor communication between each end terminal and each shared terminal which is performed over the local network. By performing the monitoring of this communication, the power management system 1 can create or edit correspondence information indicating a communication relationship between terminals which is stored in a correspondence information table 250. In addition, by obtaining a data source address and a data destination address which are included in communication data for the communication, a connection state of each terminal to the local network and terminal information of each terminal can be obtained and thus a terminal information table 270 can be updated.

Note that a power management apparatus 10 and the router apparatus 750 in the power management system 1 according to the first variant may be housed in the same casing or may be connected as being in different casings.

### Second Variant of the First Embodiment>

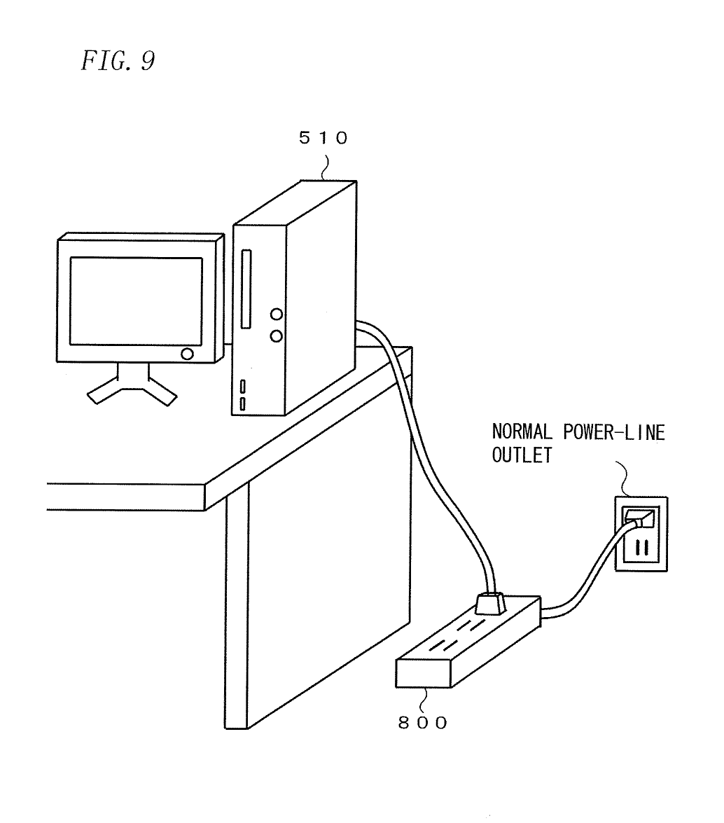

FIG. 9 is a diagram schematically showing a part of a configuration of a power management system 1 according to a second variant of the first embodiment. The power management system 1 according to the second variant of the first embodiment includes a power strip 800. A detection apparatus that detects a power state of an end terminal and a control apparatus that controls the power to a shared terminal are housed in the power strip 800 as being in the same casing. By connecting power plugs of the end terminal and the shared terminal to the power strip 800, the end terminal and the shared terminal can secure power lines and can be used as terminals of the power management system 1. Since the control apparatus is included in the power strip 800 which carries the power line of the shared terminal, control of the power state of the shared terminal by the control apparatus can be easily performed.

According to the power management system 1 according to the second variant of the first embodiment, a detection apparatus and a control apparatus are installed in all of the outlets on the power strip 800 and thus an end terminal and a shared terminal may be connected to any outlet. Therefore, a connection can be completed by a simple procedure such as inserting a power plug of a terminal into an outlet on the power strip 800, and thus the time and trouble required for wiring for installation, etc., can be reduced. In addition, by employing the form of a power strip, it can be easily mounted at a location where an end terminal and a shared terminal are installed.

Though not shown, terminal connection information indicating which end terminal or which shared terminal an apparatus connected to the outlet on the power strip 800 is, is held in a terminal information table 270 or other information tables, and a power management apparatus 10 performs power management based on the information.

On an office floor or in a home where the power management system 1 according to the second variant of the first embodiment is installed, an end terminal and a shared terminal are often used at locations very close to each other. In view of such circumstances, by connecting a plurality of end terminals and a plurality of shared terminals to the power strip 800, power management of the plurality of end terminals and the plurality of shared terminals can be performed with the single power strip 800. Therefore, a user does not need to connect an apparatus connected to the power strip 800 by distinguishing whether the apparatus is an end terminal or a shared terminal, and only by connecting an end terminal and a shared terminal to the power strip 800, the user can finish connection work for terminals of the power management system 1, which is easy and convenient for the user. In addition, comparing with the case in which a detection apparatus and a control apparatus are installed one by one for each end terminal and each shared terminal, the number of apparatuses forming the power management system 1 is reduced, enabling the simplification of the hardware configuration. Hence, the costs required to install the power management system 1 according to the second variant of the first embodiment can be suppressed. In this case, the above-described connection information is set for each outlet on the power strip 800, and the power management apparatus 10 performs power management by distinguishing between terminals connected to the outlets on the power strip.

### Third Variant of the First Embodiment

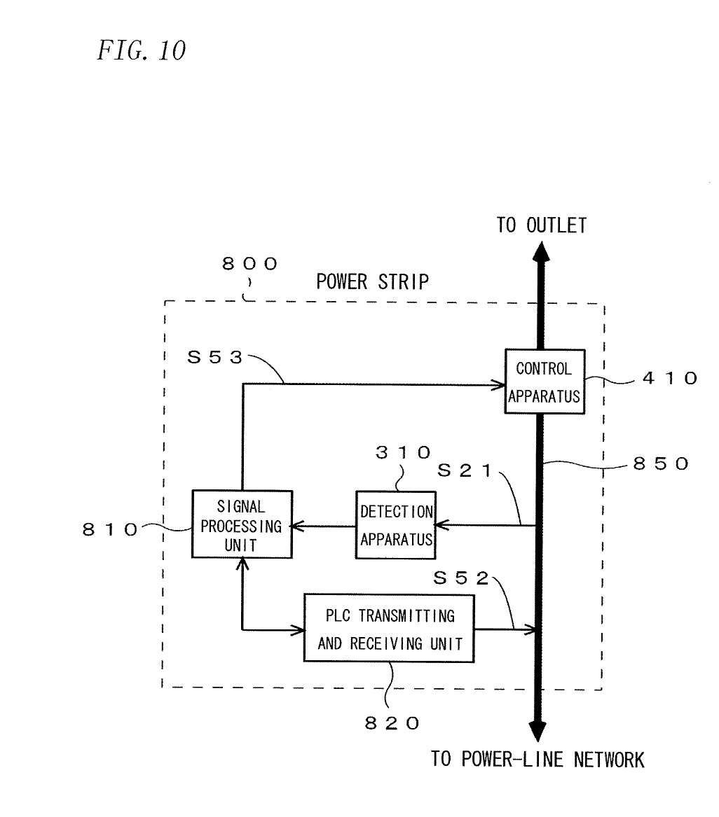

FIG. 10 is a diagram schematically showing a configuration of a power strip 800 included in a power management system 1 according to a third variant of the first embodiment. The power strip 800 includes a detection apparatus 310, a control apparatus 410, a signal processing unit 810, and a PLC transmitting and receiving unit 820. In addition, the power strip 800 includes a power line 850 to which power is supplied from a power-line network. Passage and non-passage of current through the power line 850 are controlled by the control apparatus 410. Note that, though not shown, a power management apparatus 10 included in the power management system 1 according to the third variant of the first embodiment also includes a PLC transmitting and receiving unit so that PLC (Power line communication) can be performed with the power strip 800 over the power-line network.

According to the power management system 1 according to the third variant of the first embodiment, the detection apparatus 310 detects a change in the power state of an end terminal connected to the power strip 800, from a current flowing through the power line. This detection information is subjected to signal processing by the signal processing unit 810 and the processed detection information is transmitted, as a PLC signal, to the power management apparatus 10 by the PLC transmitting and receiving unit 820. The power management apparatus 10 starts power management control based on the detection information included in the received PLC signal. If there is a shared terminal whose power is to be controlled, then the power management apparatus 10 transmits, by PLC, an instruction signal S13 to the power strip 800 to which the shared terminal is connected. The PLC transmitting and receiving unit 820 having received the instruction signal S13 over the power-line network outputs the instruction signal S13 to the signal processing unit 810, and the signal processing unit 810 outputs a control instruction S53 to the control apparatus 410 so as to control the power to the target terminal. Then, the control apparatus 410 having the control instruction S53 inputted thereto controls the power line to control the power to the shared terminal connected to the power strip 800.

In the power management system 1 according to the third variant of the first embodiment, exchange of signals between the power strip 800 including a detection apparatus and a management apparatus and the power management apparatus 10 is performed by PLC and thus communication can be performed using an existing power-line network. Therefore, the power management system 1 can be provided in which there is no need to separately wire a communication line and thus costs and efforts for installation of a communication line are not required.

### Fourth Variant of the First Embodiment

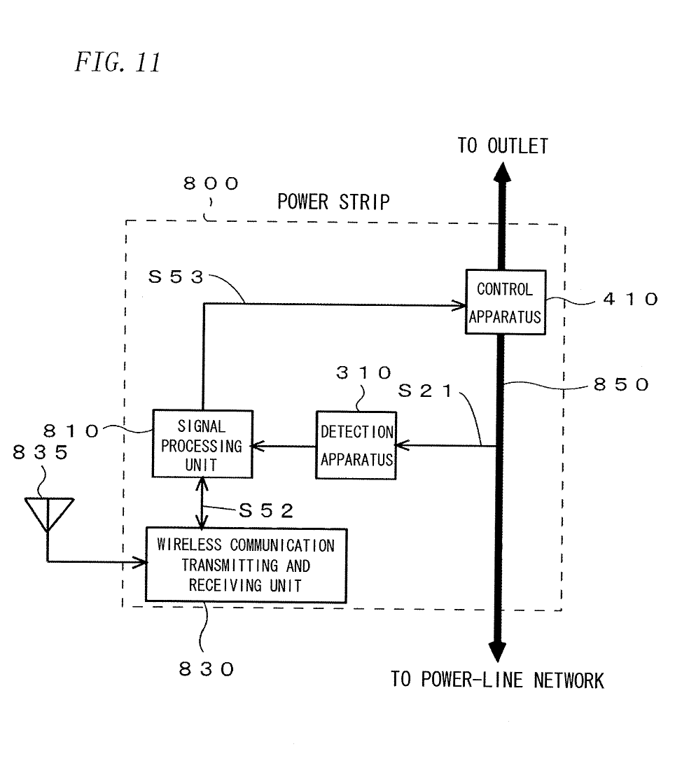

FIG. 11 is a diagram schematically showing a configuration of a power strip 800 included in a power management system 1 according to a fourth variant of the first embodiment. The power strip 800 includes a detection apparatus 310, a control apparatus 410, a signal processing unit 810, a wireless communication transmitting and receiving unit 830, and an antenna 835. In addition, the power strip 800 includes a power line 850 to which power is supplied from a power-line network. Passage and non-passage of current through the power line 850 are controlled by the control apparatus 410. Note that, though not shown, a power management apparatus 10 included in the power management system 1 according to the fourth variant of the first embodiment also includes a wireless communication transmitting and receiving unit and an antenna for performing wireless communication.

According to the power management system 1 according to the fourth variant of the first embodiment, the detection apparatus 310 detects a change in the power state of an end terminal connected to the power strip 800, from a current flowing through the power line. This detection information is subjected to signal processing by the signal processing unit 810 and the processed detection information is transmitted, as a radio signal, to the power management apparatus 10 by the wireless communication transmitting and receiving unit 830, using the antenna 835. The power management apparatus 10 starts power management control based on the detection information included in the received radio signal. If there is a terminal whose power is to be controlled, then the power management apparatus 10 transmits, by wireless communication, an instruction signal S13 to the power strip 800 to which the terminal is connected. The wireless communication transmitting and receiving unit 830 having received the instruction signal S13 by the antenna 835 outputs the instruction signal S13 to the signal processing unit 810, and the signal processing unit 810 outputs a control instruction S53 to the control apparatus 410 so as to control the power to the target terminal. The control apparatus 410 having the control instruction S53 inputted thereto controls the power line to control the power to the shared terminal connected to the power strip 800.

In the power management system 1 according to the fourth variant of the first embodiment, exchange of signals between the power strip 800 including a detection apparatus and a management apparatus and the power management apparatus 10 is performed by wireless communication and thus communication can be performed without using a communication wiring line. Therefore, the power management system 1 can be provided in which there is no need to separately wire a communication line and thus costs and efforts for installation of a communication line are not required.

### Second Embodiment

An information processing apparatus 11 according to a second embodiment of the present invention is connected to a network and observes communication on the network and performs, based on the amount of communication and terminal information for the communication, an editing process for editing correspondence information indicating which terminals on the network perform communication with each other with special association.

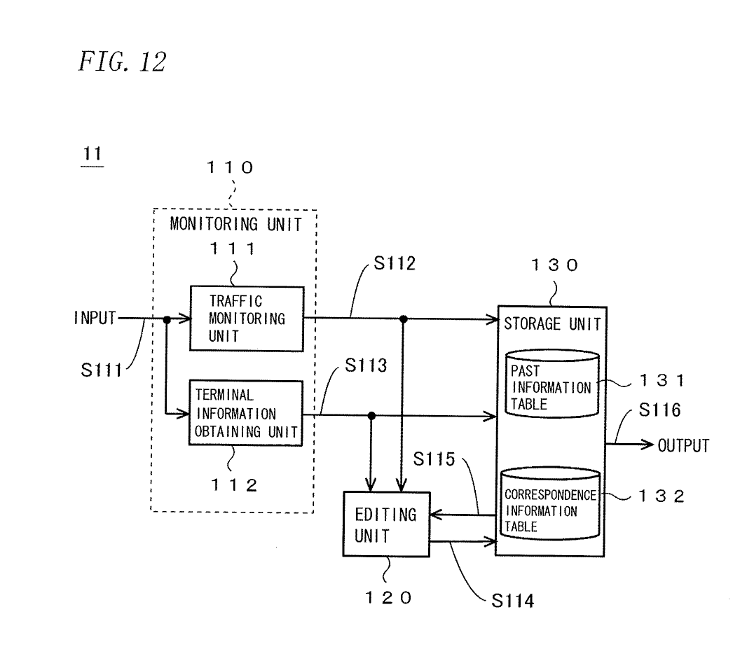

FIG. 12 is a block diagram schematically showing a configuration of the information processing apparatus 11 according to the second embodiment of the present invention. The information processing apparatus 11 includes a monitoring unit 110 which is observing means; an editing unit 120 which is editing means; and a storage unit 130. In addition, the storage unit 130 has a past information table 131 and a correspondence information table 132. Furthermore, the monitoring unit 110 includes a traffic monitoring unit 111 which is detecting means; and a terminal information obtaining unit 112. The connection relationship between the components of the information processing apparatus 11 will be described. An input signal S111 to the information processing apparatus 11 is inputted to the traffic monitoring unit 111 and the terminal information obtaining unit 112 in the monitoring unit 110. An output signal S112 from the traffic monitoring unit 111 is inputted to the editing unit 120 and the storage unit 130. An output signal S113 from the terminal information obtaining unit 112 is inputted to the editing unit 120 and the storage unit 130. An output signal S114 from the editing unit 120 is inputted to the storage unit 130. An output signal S115 from the storage unit 130 is inputted to the editing unit 120. An output signal S116 from the storage unit 130 serves as an output from the information processing apparatus 11.

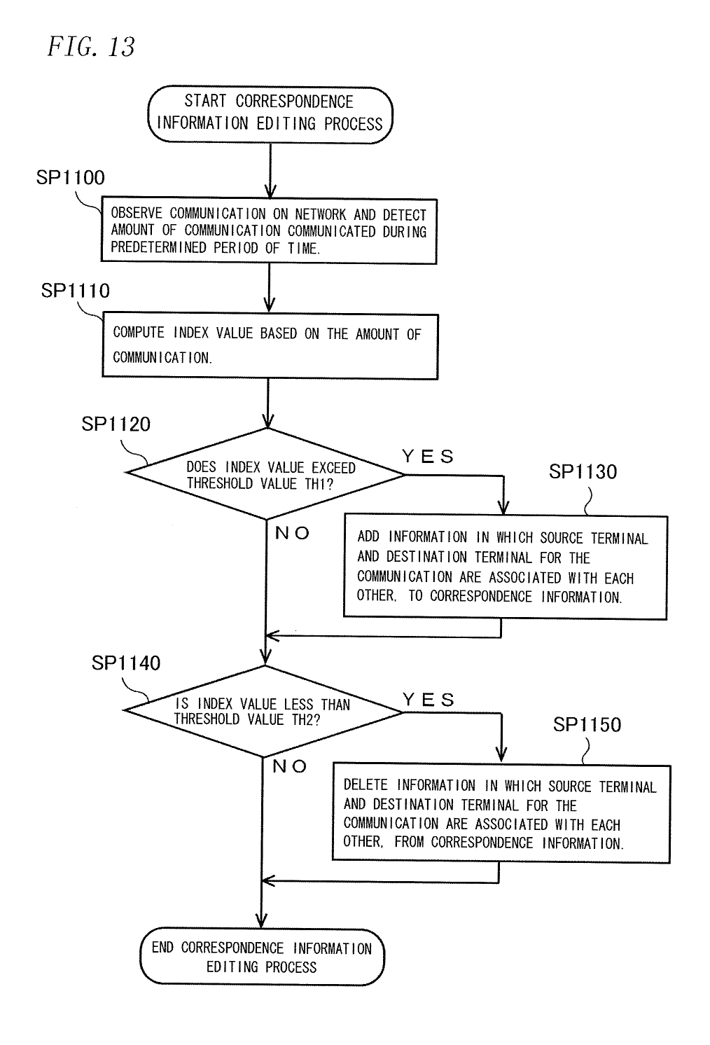

Next, the operation of the information processing apparatus 11 according to the embodiment of the present invention will be described. FIG. 13 is a flowchart showing operations in a correspondence information editing process performed by the information processing apparatus 11 according to the embodiment of the present invention. Description of a correspondence information editing process performed by the information processing apparatus 11 will be made below using FIG. 13.

At step SP1100, the information processing apparatus 11 connected to a network observes, by the monitoring unit 110, communication performed on the network. Then, communication data S111 for the communication is captured in the monitoring unit 110, and the communication data S111 is inputted to the traffic monitoring unit 111 and the terminal information obtaining unit 112. The traffic monitoring unit 111 detects the number of communication packets contained in the communication data S111 during a predetermined unit of time, and outputs amount-of-communication information S112 including the detected number of communication packets to the editing unit 120 and the storage unit 130.

The terminal information obtaining unit 112 obtains communication source addresses and communication destination addresses described in the packet headers of the communication packets contained in the communication data S111, and outputs terminal information S113 including terminal information such as MAC (Media Access Control) addresses and IP (Internet Protocol) addresses of a source terminal and a destination terminal for the communication, to the editing unit 120 and the storage unit 130. The amount-of-communication information S112 and the terminal information S113 for the observed communication are classified by a pair of terminals performing the communication, and are held in the past information table 131 in the storage unit 130 on a unit-of-detection-time basis.

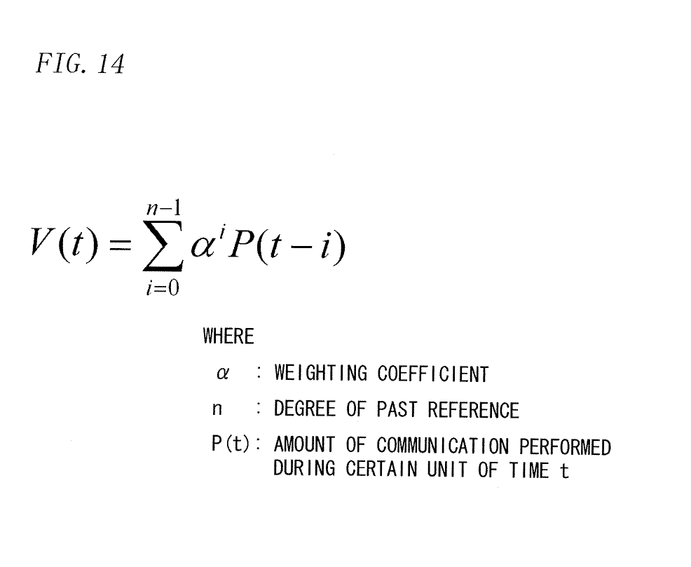

Then, in step SP1110, the editing unit 120 computes, based on the amount-of-communication information S112 inputted thereto, an index value V which is used to edit information for associating the source terminal with the destination terminal which have performed the communication. FIG. 14 shows a computation expression used for computation of the index value V. In the expression in FIG. 14, V(t) is the index value V for a certain unit of time t, α is the weighting coefficient which is a weighting value (note that α is a real number between 0 and 1, inclusive), n is the degree of past reference (note that n is a positive integer), and P(t) is the amount of communication for the communication performed during a certain unit of time t and is the number of communication packets communicated during the unit of time. The weighting coefficient α and the degree of past reference n are set values and may be set in advance upon using the information processing apparatus 11 or may be set by an external input.

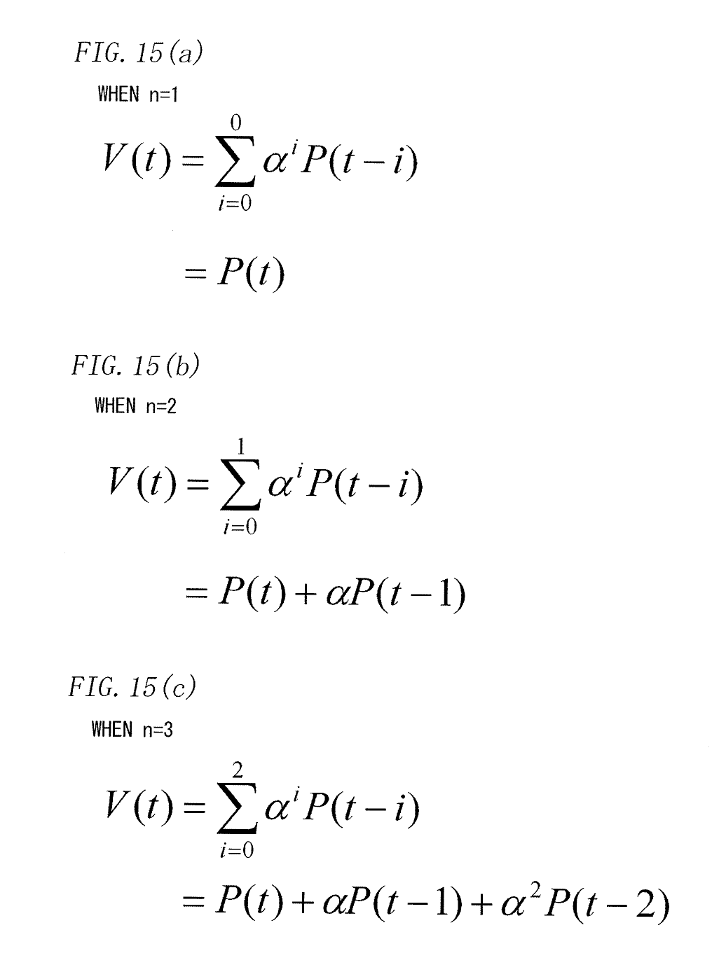

Here, FIG. 15 shows computation expressions for determining index values V(t) for when n is 1 to 3. When n is 1, the index value V(t) for a unit of time t is the amount of communication P(t) for the communication performed during the unit of time t. That is, when the degree of past reference n is 1, without referring to the amount of past communication, amount-of-communication information S112 which is currently detected is used as an index value V as it is. When n is 2, the index value V(t) for a unit of time t is a value obtained by adding a number obtained by multiplying the amount of communication P(t−1) for the communication performed during a unit of time t−1 by the weighting coefficient α, to the amount of communication P(t) for the communication performed during the unit of time t.

When, upon periodically observing communication between the terminals, the information processing apparatus 11 detects the amount of communication for a certain unit of time t, in each of a plurality of detections performed by the observation, the unit of time t−1 indicates a unit of time during which detection of the amount of communication previous to detection of the amount of communication performed during the unit of time t is performed, t−2 indicates a unit of time during which the second previous detection of the amount of communication is performed, t−3 indicates a unit of time during which the third previous detection of the amount of communication is performed, and t−x indicates a unit of time during which the x-th previous detection of the amount of communication to the detection performed during the unit of time t is performed. For example, when the unit of time is three hours and detection of the amount of communication is performed at all times, if P(t) is the amount of communication detected during a period, one to four hours ago from the present time, then P(t−1) is the amount of communication detected during a period, four to seven hours ago, and P(t−2) is the amount of communication detected during a period, seven to ten hours ago.

That is, when n is 2, the amount of past communication detected during the unit of time t−1 is reflected in the index value V. Likewise, the index value V(t) for when n is 3 is a value obtained by adding a number obtained by multiplying the amount of communication P(t−1) for the communication performed during the unit of time t−1 by the weighting coefficient α and a number obtained by multiplying the amount of communication P(t−2) for the communication performed during the unit of time t−2 by the square of the weighting coefficient α, to the amount of communication P(t) for the communication performed during the unit of time t. As such, as the number of the degree of past reference n is increased from 1, the index value V(t) is computed such that the amount of more past old communication is reflected therein. Here, the amounts of communication for the communication in the past used for computation of the index value V(t), such as the amount of communication P(t−1) and the amount of communication P(t−2), are past communication information which is held in the past information table 131 in the storage unit 130 in step SP1100, and past communication information S115 is called from the storage unit 130 to the editing unit 120, as necessary.

When the weighting coefficient α is set to 0.9 in the case of n being 3, the index value V(t) is a value obtained by adding a number obtained by multiplying the amount of communication P(t−1) for the communication performed during the unit of time t−1 by 0.9 and a number obtained by multiplying the amount of communication P(t−2) for the communication performed during the unit of time t−2 by 0.81, to the amount of communication P(t) for the communication performed during the unit of time t, and thus the influence of the amount of past communication on the index value V becomes relatively large. On the other hand, when the weighting coefficient α is set to 0.1 in the case of n being 3, the index value V(t) is a value obtained by adding a number obtained by multiplying the amount of communication P(t−1) for the communication performed during the unit of time t−1 by 0.1 and a number obtained by multiplying the amount of communication P(t−2) for the communication performed during the unit of time t−2 by 0.01, to the amount of communication P(t) for the communication performed during the unit of time t, and thus the influence of the amount of past communication on the index value V becomes relatively small. As such, by setting the weighting coefficient α such that the weighting coefficient α is adjusted between 0 and 1, the degree to which the amount of past communication is reflected in the computation of the index value V(t) can be adjusted.

Then, in step SP1120, the editing unit 120 determines whether the index value V computed in step SP1110 exceeds a predetermined threshold value TH1. If the index value V exceeds the threshold value TH1 (i.e., if the determination result in step SP1120 is “YES”), then the editing unit 120 performs an operation in step SP1130 which will be described later. On the other hand, if the index value V does not exceed the threshold value TH1 (i.e., if the determination result in step SP1120 is “NO”), then the editing unit 120 performs an operation in step SP1140 which will be described later.

If the determined in step SP1120 is “YES”, then in step SP1130 the editing unit 120 outputs, as a signal 5114, information in which terminals in a pair having performed communication on which the amount-of-communication information used to compute the index value V is based, are associated with each other as being a pair of terminals having a special communication relationship, to the storage unit 130 and thereby adds the information to the correspondence information table 132 held in the storage unit 130. If, at this time, there is no correspondence information table 132, then the editing unit 120 creates a correspondence information table 132 specifying information in which the terminals are associated with each other.

Then, in step SP1140, the editing unit 120 determines whether the index value V computed in step SP1110 is less than a predetermined threshold value TH2. If the index value V is less than the threshold value TH2 (i.e., if the determination result in step SP1140 is “YES”), then the editing unit 120 performs an operation in step SP1150 which will be described later. On the other hand, if the index value V is not less than the threshold value TH2 (i.e., if the determination result in step SP1140 is “NO”), then the information processing apparatus 11 ends the correspondence information editing process.

If the determination in step SP1140 is “YES”, then in step SP1150, the editing unit 120 outputs, as a signal S114, information in which terminals in a pair having performed communication on which the amount-of-communication information used to compute the index value V is based, are associated with each other as being not a pair of terminals having a special communication relationship, to the storage unit 130, and thereby deletes the information from the correspondence information table 132 held in the storage unit 130. If, at this time, all of the contents of the correspondence information table 132 have been deleted as a result of the deletion and thus the correspondence information table 132 has become empty, then the editing unit 120 may delete the correspondence information table 132 itself which is held in the storage unit 130.

Then, the information processing apparatus 11 according to the embodiment of the present invention performs a correspondence information editing process shown in steps SP1100 to SP1150 on each of all of the pairs of source terminals and destination terminals for communication observed over the network, to determine whether each pair of terminals performing communication over the network has a communication relationship with special association. Then, the information processing apparatus 11 edits, based on the determination results, the correspondence information table 132 holding terminal information of pairs of terminals having a communication relationship with special association.

According to the information processing apparatus 11 according to the embodiment of the present invention, since an index value based on the number of communication packets communicated by each pair of terminals performing communication is computed, a determination can be accurately made as to whether each pair of terminals performing the communication has a communication relationship with special association. Then, by using the determination results, correspondence information specifying pairs of terminals performing communication with each other with special association among the terminals connected to the network can be appropriately edited. Since the correspondence information is edited by observing communication on the network, even if the types or number of terminals connected to the network have been changed, the information processing apparatus 11 edits the correspondence information by observing communication having been changed in accordance with the change, and thus users can obtain correspondence information in accordance with the network state. Hence, by performing power control, etc., using the correspondence information, even if the network state has been changed, the users do not need to change the settings, enabling improvement in convenience for the users.

In addition, according to the information processing apparatus 11 according to the embodiment of the present invention, computation of an index value used for the determination uses a number obtained by multiplying the amount of communication detected in the past by a weighting coefficient. By this, a determination taking into account not only communication currently performed but also communication performed in the past can be made, and furthermore, correspondence information in which the degree of importance of communication by the elapsed time from communication is changed can also be edited.

Note that although description is made exemplifying the values of the degree of past reference n and the weighting coefficient α, the degree of past reference n and the weighting coefficient α are set values and thus are not limited to the exemplified values. Upon using the information processing apparatus 11 of the embodiment of the present invention, those values are set such that the values are appropriately adjusted in accordance with individual network conditions. Note also that for detection of the amount of communication during a predetermined period of time which is performed by the monitoring unit 110 of the information processing apparatus 11, detection by a predetermined unit of time may be repeatedly performed at all times or sampling detection may be performed such that a time interval at which detection by a predetermined unit of time is performed is set.

### First Variant of the Second Embodiment

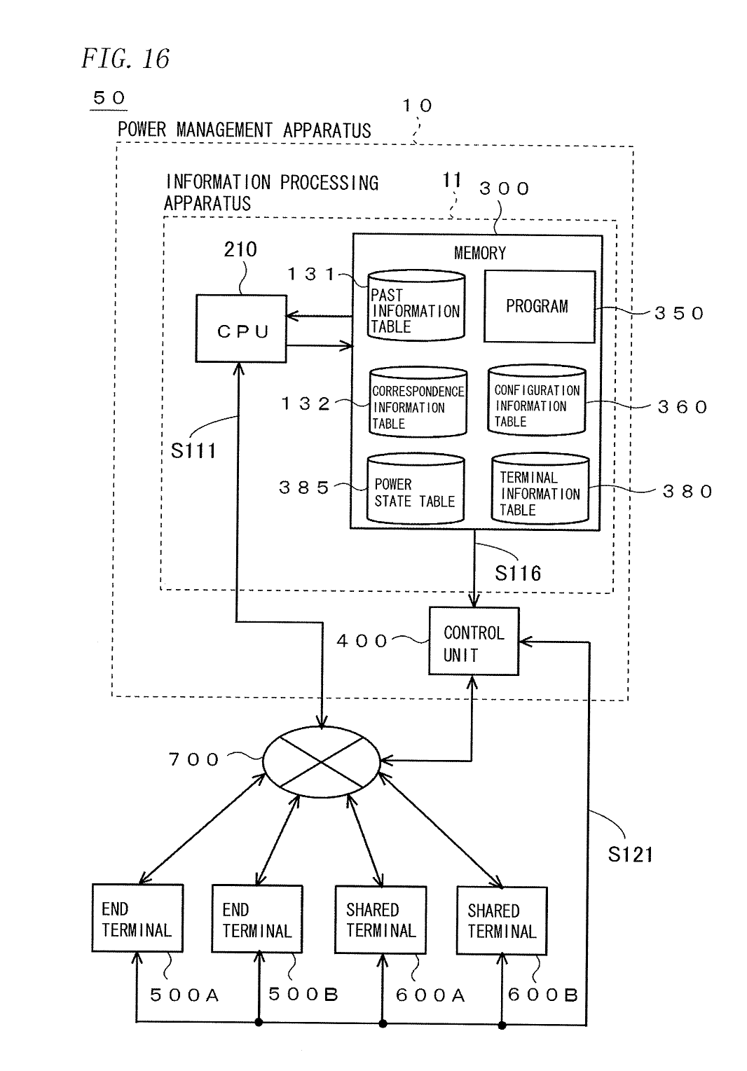

FIG. 16 is a block diagram schematically showing a configuration of a power management system 50 including an information processing apparatus 11 according to a first variant of the second embodiment. The power management system 50 includes a power management apparatus 10, end terminals 500 (500A and 500B) which are first apparatuses, shared terminals 600 (600A and 600B) which are second apparatuses, and a network 700. Furthermore, the power management apparatus 10 includes the information processing apparatus 11 and a control unit 400 which is control means. At this time, the information processing apparatus 11 may be a general-purpose computer system. In that case, a correspondence information editing function of the information processing apparatus 11 is implemented by a CPU 210, which is included in the information processing apparatus 11, executing a program 350 called from a memory (recording medium) 300. Furthermore, the function of the storage unit 130 of the information processing apparatus 11 shown in FIG. 12 is performed by the memory 300, and the memory 300 holds a past information table 131, a correspondence information table 132, a configuration information table 360, a terminal information table 380, a power state table 385, and the program 350. Note that the end terminals in the first variant include, for example, terminals that are operated by users, such as personal computers and televisions, and the shared terminals include, for example, terminals that are shared among the users, such as shared servers, NASs (Network Attached Storages), hubs, switches, routers, STBs (Set Top Boxes), and DVD recorders/players.

In the power management system 50, the control unit 400 manages the power to the end terminals 500 and the shared terminals 600, based on correspondence information specifying terminals having a special communication relationship among the end terminals 500 and the shared terminals 600 which perform communication over the network 700. Then, the information processing apparatus 11 observes communication on the network 700 and the correspondence information is edited based on the amount of communication for the communication.

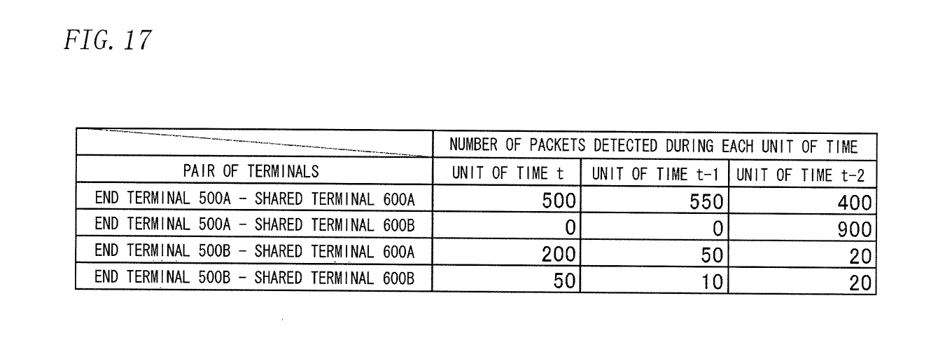

FIG. 17 shows an example of the number of communication packets for communication performed by the end terminals 500A and 500B and the shared terminals 600A and 600B in the power management system 50. The operations of the information processing apparatus 11 and the power management system 50 will be described using the numbers of communication packets for communication performed on the network 700 which are shown in FIG. 17. It is assumed that the information processing apparatus 11 at this time has the functions of the components shown in the block diagram of FIG. 12 and performs a correspondence information editing process shown in the flowchart of FIG. 13.

First, in step SP1100, a traffic monitoring unit 111 and a terminal information obtaining unit 112 of the information processing apparatus 11 observe communication over the network 700 and obtain communication data S111. Then, the terminal information obtaining unit 112 obtains terminal information included in the communication to determine between which terminals the communication is performed, and the traffic monitoring unit 111 detects the number of communication packets transmitted and received during a predetermined period of time, for each pair of terminals having performed the communication (the detection results of the number of communication packets are the numbers of packets detected during a unit of time t in FIG. 17. A unit of time during which detection previous to this detection is performed is represented by t−1 and a unit of time during which the second previous detection is performed is represented by t−2, and the numbers of packets detected during those units of time are shown in FIG. 17. The numbers of communication packets for the past detection are that information detected by a monitoring unit 110 during each of the units of time in the past is held in the past information table 131 in the memory 300.).

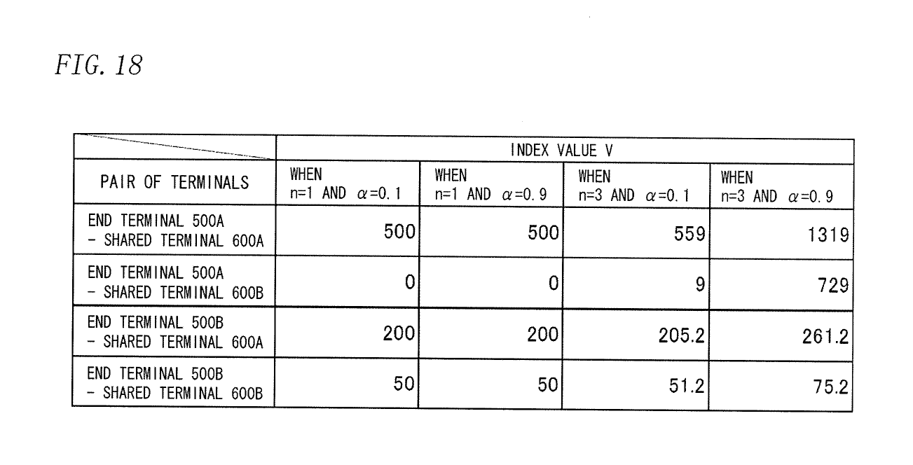

Then, in step SP1110, an editing unit 120 of the information processing apparatus 11 computes an index value V for each pair of terminals having performed the communication, based on the numbers of communication packets shown in FIG. 17. Here, FIG. 18 shows the values of the index values V for the case of using the numbers of communication packets in FIG. 17. In addition, FIG. 18 shows the index values V for when the degree of past reference n is 1 and the weighting coefficient α is 0.1, when the degree of past reference n is 1 and the weighting coefficient α is 0.9, when the degree of past reference n is 3 and the weighting coefficient α is 0.1, and when the degree of past reference n is 3 and the weighting coefficient α is 0.9.

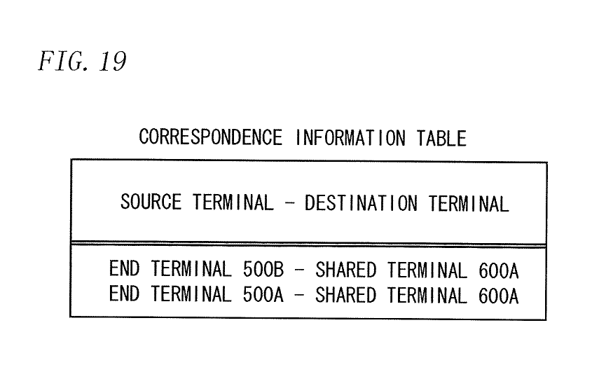

Then, in step SP1120, the editing unit 120 of the information processing apparatus 11 determines whether the index values V exceed a predetermined threshold value TH1. Here, taking as an example the case in which the degree of past reference n is set to 1, the weighting coefficient α is set to 0.1, and the predetermined threshold value TH1 is set to 250, from FIG. 18, the index value V of a pair of ‘end terminal 500A—shared terminal 600A’ is ‘500’ and thus exceeds the threshold value TH1. Therefore, in step SP1130, the editing unit 120 of the information processing apparatus 11 determines that ‘end terminal 500A—shared terminal 600A’ have a communication relationship with special association, and thus adds ‘end terminal 500A—shared terminal 600A’ to the correspondence information table 132 held in the memory 300. FIG. 19 is an example of the correspondence information table 132. The correspondence information table 132 holds information on pairs of terminals performing communication with special association over the network 700, which is determined by the editing unit 120 based on the numbers of communication packets.

Then, in step SP1140, the editing unit 120 of the information processing apparatus 11 determines whether the index values V are less than a predetermined threshold value TH2. Here, taking as an example the case in which the degree of past reference n is set to 1, the weighting coefficient α is set to 0.1, and the predetermined threshold value TH2 is set to 100, from the index values V in FIG. 18, the index value V of a pair of ‘end terminal 500A—shared terminal 600B’ is ‘0’ and the index value V of a pair of ‘end terminal 500B—shared terminal 600B’ is ‘50’ and thus the index values V of ‘end terminal 500A—shared terminal 600B’ and ‘end terminal 500B—shared terminal 600B’ are less than the threshold value TH2. Therefore, in step SP1150, the editing unit 120 of the information processing apparatus 11 determines that ‘end terminal 500A—shared terminal 600B’ and ‘end terminal 500B—shared terminal 600B’ do not have a communication relationship with special association, and thus deletes ‘end terminal 500A—shared terminal 600B’ and ‘end terminal 500B—shared terminal 600B’ from the correspondence information table 132 held in the memory 300.

Therefore, when the degree of past reference n is set to 1, the weighting coefficient α is set to 0.1, the threshold value TH1 is set to 250, and the threshold value TH2 is set to 100, in the correspondence information table 132 for when the amounts of communication in FIG. 17 are detected, ‘end terminal 500A—shared terminal 600A’ is added and ‘end terminal 500A—shared terminal 600B’ and ‘end terminal 500B—shared terminal 600B’ are deleted. For a pair of terminals that has been neither added nor deleted by the determination, e.g., ‘end terminal 500B—shared terminal 600A’, correspondence information obtained before this editing process is maintained (when the pair of terminals is present in the correspondence information obtained before the editing, the pair of terminals is held as it is in the correspondence information, and when the pair of terminals is not present in the correspondence information obtained before the editing, the pair of terminals is not included in the correspondence information as before).

Meanwhile, considering the case in which the degree of past reference n is set to 3, the weighting coefficient α is set to 0.9, the threshold value TH1 is set to 250, and the threshold value TH2 is set to 100, from the index values V in FIG. 18, ‘end terminal 500A—shared terminal 600A’, ‘end terminal 500A—shared terminal 600B’, and ‘end terminal 500B—shared terminal 600A’ are determined to have a communication relationship with special association, and thus are added to the correspondence information table 132 held in the memory 300. In addition, ‘end terminal 500B—shared terminal 600B’ is determined to have no communication relationship with special association, and thus is deleted from the correspondence information table 132 held in the memory 300. As such, by changing the values of the degree of past reference n and the weighting coefficient α, it is possible to adjust how far back the amount of past communication is to be reflected in correspondence information.

Furthermore, the control unit 400 of the power management system 50 can know which terminals among the terminals, the end terminals 500 and the shared terminals 600, connected to the network 700 have a communication relationship with each other with special association, by referring to the correspondence information table 132 edited by the information processing apparatus 11 and receiving terminal correspondence information S116. Therefore, by referring to the correspondence information, the power management system 50 can perform power management such as reducing the power consumption of the shared terminals 600 while considering user convenience.

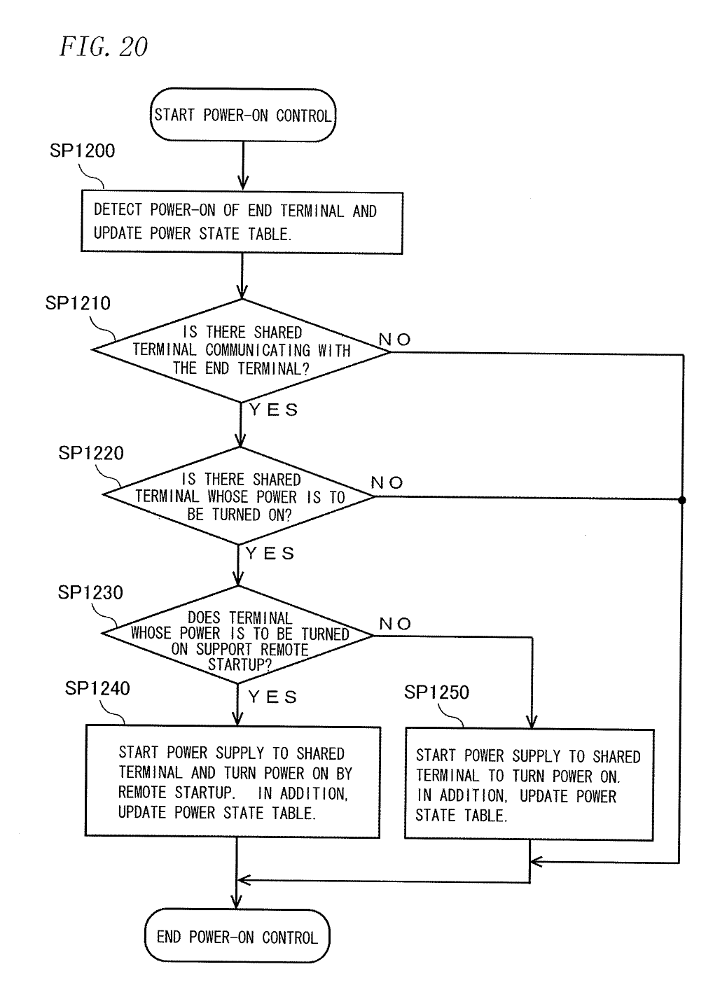

Now, an example of power management performed on a shared terminal 600 using correspondence information in the correspondence information table 132 edited by the information processing apparatus 11 according to the present embodiment will be described. FIG. 20 is a flowchart showing power-on control operations where, when the power to an end terminal 500 is turned on, the power management system 50 turns on the power to a shared terminal 600. Description of the power-on control operations will be made using FIG. 20.

When there is an end terminal 500 whose power has been turned on from off among the end terminals 500, first, in step SP1200, the control unit 400 of the power management system 50 detects a change in the power state of the end terminal 500. For a method for performing this detection, the control unit 400 may receive a power-on signal from the end terminal 500, or the control unit 400 may monitor the power consumption of the end terminal 500 and detect power-on by the event that the power consumption of the end terminal 500 has reached a predetermined threshold value or more.

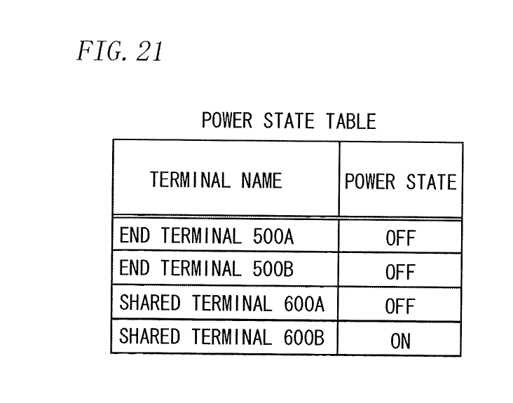

Then, the control unit 400 having detected the power-on of the end terminal 500 accesses the memory 300 to rewrite the item for the power state in the power state table 385 held in the memory 300 to a power state conforming to a result of the detection. FIG. 21 shows an example of the power state table 385. As shown in FIG. 21, the power state table 385 holds whether the power state of each terminal which performs communication over the network 700 is currently on or off. The information about the power states in the power state table 385 is held such that when the power states of the respective terminals have been changed, the changes in power state are reflected one by one.

Then, in step SP1210, the control unit 400 determines whether there is a target shared terminal 600 on which power-on control is performed. Specifically, the control unit 400 reads correspondence information from the correspondence information table 132 held in the memory 300. The control unit 400 further identifies, based on the correspondence information, a shared terminal 600 having a communication relationship with the end terminal 500 whose power state is detected to have been changed from off to on in step SP1200, and determines whether the shared terminal 600 having a communication relationship is present. At this time, if there is a shared terminal 600 having a communication relationship with the end terminal 500 whose power has been turned on (i.e., if the determination in step SP1210 is “YES”), then the control unit 400 performs an operation in step SP1220 which will be described later. On the other hand, if there is no shared terminal 600 having a communication relationship with the end terminal 500 whose power has been turned on (i.e., if the determination in step SP1210 is “NO”), then the power management system 50 ends the power-on control.

Then, in step SP1220, the control unit 400 checks the power state of the shared terminal 600 having been determined in step SP1210 to have a communication relationship with the end terminal 500 based on the correspondence information, by referring to the power state table 385 held in the memory 300. Then, the control unit 400 determines whether there is a shared terminal 600 which has a communication relationship with the end terminal 500 whose power has been turned on from off, and whose power state is off despite the fact that due to the power state of the end terminal 500 having been changed to on, the possibility of the shared terminal 600 performing data communication over the network 700 arises and thus the power to the shared terminal 600 is to be turned on.

Here, if there is a shared terminal 600 whose power is to be turned on but whose power state is off (i.e., if the determination in step SP1220 is “YES”), then the control unit 400 performs an operation in step SP1230 which will be described later. At this time, if there are a plurality of shared terminals 600 whose power is to be turned on, then power-on control in and after step SP1230 is performed on all of the terminals. If, as a result of referring to the power state table 385, the power states of all of the shared terminals 600 whose power is to be turned on are already on (i.e., if the determination in step SP1220 is “NO”), then the power management system 50 ends the power-on control.

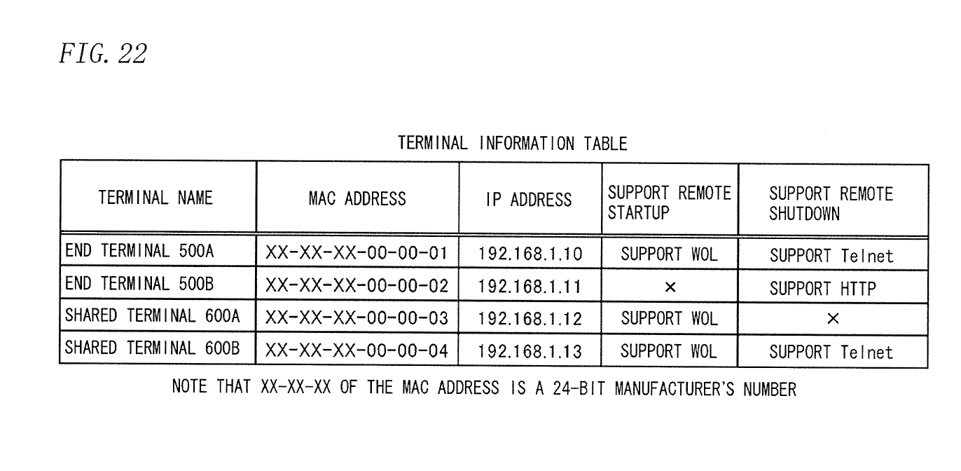

Then, in step SP1230, the control unit 400 reads, from the terminal information table 380 held in the memory 300, terminal information of the shared terminal 600 determined in step SP1220 that its power is to be turned on, to determine whether the shared terminal supports remote startup. FIG. 22 shows an example of the terminal information table. As shown in FIG. 22, the terminal information table 380 holds terminal information such as the addresses of each of the terminals and whether each of the terminals supports remote startup and remote shutdown. The terminal information is set in advance when performing power management using the power management system 50, but when the terminal information has been changed in the middle of power management, the terminal information in the terminal information table 380 is to be rewritten and updated.

Here, if it is determined by referring to the terminal information that the shared terminal 600 whose power is to be turned on is a terminal supporting remote startup (i.e., if the determination in step SP1230 is “YES”), then the control unit 400 performs an operation in step SP1240 which will be described later. On the other hand, if the shared terminal 600 whose power is to be turned on is not a terminal supporting remote startup (i.e., if the determination in step SP1230 is “NO”), then the control unit 400 performs an operation in step SP1250 which will be described later.

Then, in step SP1240, the control unit 400 transmits an instruction signal 5121 instructing to start power supply, to the shared terminal 600 whose power is to be turned on, to start power supply. Furthermore, an instruction signal instructing to perform remote startup over the network 700 is transmitted, and the shared terminal 600 having received the instruction signal performs remote startup. Here, the instruction signal transmitted to the shared terminal may be a remote startup code called a magic packet specified by the WOL (Wake On LAN) function, or may be other power management instruction signals performing remote startup.

In addition, here, when the power to the shared terminal is turned on from off by remote startup, the control unit 400 accesses the memory 300 to rewrite the corresponding item for the power state of the shared terminal in the power state table 385 from ‘off’ to ‘on’, and ends the power-on control.

Then, if the determination in step SP1230 is “NO”, then in step SP1250, the control unit 400 transmits an instruction signal 5121 instructing to start power supply to the shared terminal. The shared terminal 600 having received the instruction signal 5121 starts power supply. Furthermore, the control unit 400 accesses the memory 300 to rewrite the corresponding item for the power state of the shared terminal in the power state table 385 from ‘off’ to ‘on’, and ends the power-on control.

Now, the flow of power-on control operations will be specifically described using, as an example, the case in which the power to the end terminal 500A is turned on from off. When the power to the end terminal 500A is turned on from off, first, in step SP1200, the control unit 400 detects that the power to the end terminal 500A has been turned on. Furthermore, the control unit 400 accesses the memory 300 to rewrite the item for the power state of the ‘end terminal 500A’ in the power state table 385 from ‘off’ to ‘on’.

Then, in step SP1210, the control unit 400 accesses the memory 300 to refer to the correspondence information table 132 to check which terminal is a counterpart terminal that is specified to have a communication relationship with the end terminal 500A whose power has been turned on. Here, assuming that the correspondence information table 132 in FIG. 19 is referred to, the counterpart terminal specified to have a communication relationship with the ‘end terminal 500A’ is the ‘shared terminal 600A’. Therefore, since there is a shared terminal 600 having a communication relationship with the end terminal 500 whose power state is detected to have been changed from off to on, the determination in step SP1210 is “YES” and thus processing proceeds to step SP1220.

Then, in step SP1220, the control unit 400 accesses the memory 300 to refer to the power state table 385 to check the power state of the shared terminal 600A having a communication relationship with the end terminal 500A whose power state is detected to have been changed from off to on. Assuming that the power state table 385 in FIG. 21 is referred to, the ‘shared terminal 600A’ is ‘off’. Therefore, the control unit 400 identifies the shared terminal 600A whose power state is off, as a shared terminal whose power is to be turned on. Then, since there is a shared terminal whose power is to be turned on, the determination in step SP1220 is “YES” and thus processing proceeds to step SP1230.

Then, in step SP1230, the control unit 400 accesses the memory 300 to refer to the terminal information table 380 to determine whether the shared terminal 600A which is a terminal whose power is to be turned on supports remote startup. Here, assuming that the terminal information table 380 in FIG. 22 is referred to, since the ‘shared terminal 600A’ ‘supports WOL’, the determination in step SP1230 is “YES” and thus processing proceeds to step SP1240.

Then, in step SP1240, the control unit 400 transmits an instruction signal 5121 instructing to start power supply to the shared terminal 600A to start power supply. Then, a remote startup code specified by WOL is transmitted and the shared terminal 600A having received the remote startup code starts a remote startup sequence, whereby the power is turned on. Furthermore, the control unit 400 accesses the memory 300 to rewrite the item for the power state of the ‘shared terminal 600A’ in the power state table 385 from ‘off’ to ‘on’, and ends the power-on control.

As described above, in power-on control of the power management system 50, by detecting power-on of an end terminal 500, the power to a shared terminal 600 which is a counterpart performing communication with the end terminal can be turned on. Accordingly, when the end terminal is being used, the power to the shared terminal 600 which is a counterpart performing communication with the end terminal over the network 700 is turned on. Thus, a user of the end terminal can perform data communication with the shared terminal at any time when using the end terminal.

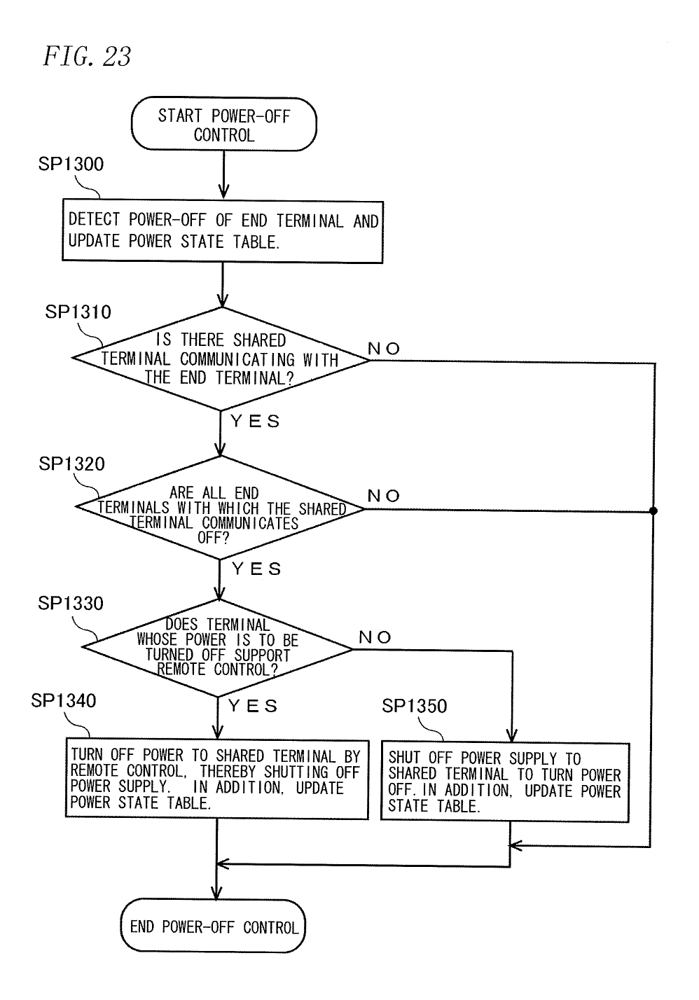

Furthermore, FIG. 23 is a flowchart showing power-off control operations performed by the power management system 50 when the power to an end terminal is turned off from on. Description of the power-off control operations will be made using FIG. 23.

When there is an end terminal 500 whose power has been turned off from on among the end terminals 500, first, in step SP1300, the control unit 400 detects a change in the power state of the end terminal 500. For a method for performing this detection, the control unit 400 may receive a power-off signal from the end terminal, or the control unit 400 may monitor the power consumption of the end terminal and detect power-off by the event that the power consumption of the end terminal has reached less than a predetermined threshold value. Then, the control unit 400 accesses the memory 300 to rewrite, based on a result of the detection, the power state of the terminal in the power state table 385 to a power state conforming to the detection result.

Then, in step SP1310, the control unit 400 determines whether there is a shared terminal 600 with which the end terminal has a communication relationship. Specifically, the control unit 400 reads correspondence information from the correspondence information table 132 held in the memory 300. The control unit 400 further identifies, based on the correspondence information, a shared terminal 600 having a communication relationship with the end terminal 500 whose power state is detected to have been changed from on to off in step SP1300, and determines whether the shared terminal is present.

If there is a shared terminal 600 having a communication relationship with the end terminal 500 whose power has been turned off (i.e., if the determination in step SP1310 is “YES”), then the control unit 400 performs an operation in step SP1320 which will be described later. Here, if there are a plurality of shared terminals 600 having a communication relationship with the end terminal 500 whose power state is detected to have been changed from on to off, then power-off control in and after step SP1320 is performed on each of the plurality of shared terminals. If, on the other hand, there is no shared terminal having a communication relationship with the terminal whose power has been turned off (i.e., if the determination in step SP1310 is “NO”), then the power management system 50 ends the power-off control.

Then, in step SP1320, the control unit 400 checks whether the shared terminal 600 having a communication relationship with the end terminal 500 whose power has been turned off has any other end terminal 500 having a communication relationship therewith than the end terminal, by referring to the correspondence information table 132 held in the memory 300. The control unit 400 further checks the power states of all end terminals 500 having a communication relationship with the shared terminal 600 having a communication relationship with the end terminal whose power has been turned off, by referring to the correspondence information table 132 and the power state table 385 which are held in the memory 300. Then, the control unit 400 determines whether the power states of all of those end terminals 500 are off. In power-off control performed by the power management system 50, when the power states of all end terminals 500 having a communication relationship with a certain shared terminal 600 are off, the power state of the shared terminal 600 is set to off.

Here, if the power states of all of the corresponding end terminals 500 are off (i.e., if the determination in step SP1320 is “YES”), then the control unit 400 performs an operation in step SP1330 which will be described later. If the power state of at least one of all of the corresponding end terminals 500 is not off (i.e., if the determination in step SP1320 is “NO”), then the power management system 50 ends the power-off control.

Then, in step SP1330, the control unit 400 reads terminal information of the shared terminal 600 having a communication relationship with the end terminal 500 whose power has been turned off in step SP1310, from the terminal information table 380 held in the memory 300 to determine whether the shared terminal supports remote control.

Here, if, as a result of referring to the terminal information, the shared terminal is a terminal supporting remote control (i.e., if the determination in step SP1330 is “YES”), then the control unit 400 performs an operation in step SP1340 which will be described later. On the other hand, if the shared terminal is not a terminal supporting remote control (i.e., if the determination in step SP1330 is “NO”), then the control unit 400 performs an operation in step SP1350 which will be described later.

Then, in step SP1340, the control unit 400 performs, over the network 700, log-in for remote control to the shared terminal 600 whose power is to be turned off because the power states of all of the end terminals 500 having a communication relationship therewith are off, and executes a shutdown command to shut down the shared terminal. Then, the control unit 400 transmits an instruction signal S121 instructing to shut off power supply, to the shared terminal, and the shared terminal having received the instruction signal S121 shuts off its power supply to turn off its power. The control unit 400 further accesses the memory 300 to rewrite the corresponding item for the power state of the shared terminal in the power state table 385 from ‘on’ to ‘off’, and ends the power-off control.

If the determination in step SP1330 is “NO”, then in step SP1350, the control unit 400 transmits an instruction signal 5121 instructing to shut off the power supply to the shared terminal. The shared terminal 600 having received the instruction signal S121 shuts off its power supply to turn off its power. The control unit 400 further accesses the memory 300 to rewrite the corresponding item for the power state of the shared terminal in the power state table 385 from ‘on’ to ‘off’, and ends the power-off control.

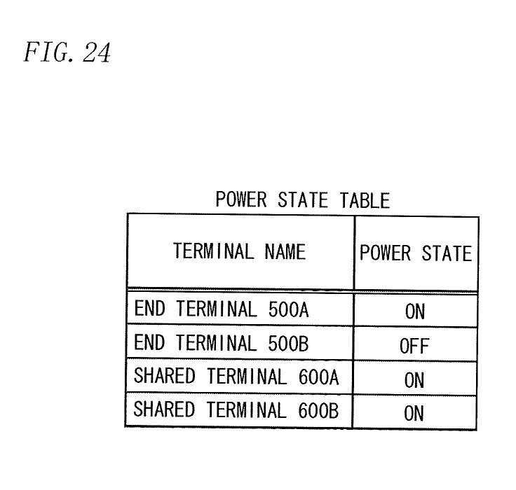

Now, the flow of power-off control operations will be specifically described using, as an example, the case in which the power to the end terminal 500A is turned off from on, when the power states of the respective terminals are those in a power state table shown in FIG. 24.

When the power to the end terminal 500A is turned off from on, first, in step SP1300, the control unit 400 detects that the power to the end terminal 500A has been turned off. The control unit 400 further accesses the memory 300 to rewrite the item for the power state of the ‘end terminal 500A’ in the power state table 385 from ‘on’ to ‘off’.

Then, in step SP1310, the control unit 400 accesses the memory 300 to refer to the correspondence information table 132 to check a counterpart terminal that is specified to have a communication relationship with the end terminal 500A whose power has been turned off. Here, assuming that the correspondence information table 132 in FIG. 19 is referred to, the counterpart terminal specified to have a communication relationship with the ‘end terminal 500A’ is the ‘shared terminal 600A’. Therefore, since there is a shared terminal 600 having a communication relationship with the end terminal 500 whose power state is detected to have been changed from on to off, the determination in step SP1310 is “YES” and thus processing proceeds to step SP1320.

Then, in step SP1320, the control unit 400 checks whether the shared terminal 600A having a communication relationship with the end terminal 500A whose power has been turned off, has any other end terminal 500 having a communication relationship therewith than the end terminal 500A, by referring to the correspondence information table 132 held in the memory 300. Referring to the correspondence information table 132 in FIG. 19, the shared terminal 600A also has a communication relationship with the end terminal 500B. Here, since the power state of the shared terminal 600A has been changed from ‘on’ to ‘off’ in step SP1300 and furthermore the power state of the shared terminal 600B is ‘off’, all of the end terminals with which the shared terminal 600A has a communication relationship are off and thus the shared terminal 600A is a terminal whose power state is to be set to off. Therefore, in the power-off control of the shared terminal 600A, the determination in step SP1320 is ‘YES’ and thus processing proceeds to step SP1330.

Then, in step SP1330, the control unit 400 accesses the memory 300 to refer to the terminal information table 380 to determine whether the shared terminal 600A which is a terminal whose power is to be turned off supports remote shutdown. Here, assuming that the terminal information table 380 in FIG. 22 is referred to, since the ‘shared terminal 600A’ ‘does not support remote shutdown’, in the power-off control of the shared terminal 600A, the determination in step SP1330 is ‘NO’ and thus processing proceeds to step SP1350.

Then, in step SP1350, the control unit 400 transmits an instruction signal S121 instructing to shut off power supply, to the shared terminal 600A. The shared terminal 600A having received the instruction signal S121 shuts off its power supply to turn off its power. The control unit 400 further accesses the memory 300 to rewrite the item for the power state of the ‘shared terminal 600A’ in the power state table 385 from ‘on’ to ‘off’, and ends the power-off control.

As described above, in the power management system 50, by power-off control, power-off of an end terminal 500 is detected and when the power states of all end terminals 500 having a communication relationship with a shared terminal 600 which is a counterpart performing communication with the end terminal are off, the power to the shared terminal can be turned off. Therefore, by using the power management system 50, power consumption can be reduced by turning off the power to a shared terminal 600 which is not going to be used because the power state of an end terminal 500 performing communication with the shared terminal 600 over the network 700 is off. In addition, since the power to the shared terminal 600 with which communication from the end terminal 500 is not going to be performed is automatically turned off, wasted power consumption caused by forgetting to turn off the power to the shared terminal 600 can be prevented.

In the power management system 50, by performing the above-described power-on control and power-off control at all times which are performed by detecting changes in the power states of the end terminals 500, when the power to an end terminal 500 is turned on, the power to a shared terminal 600 that is specified to have a communication relationship with the end terminal and thus has a chance of being used can be turned on, and the power to a shared terminal 600 having end terminals 500 which are specified to have a communication relationship with the shared terminal 600 and whose power states are all off can be turned off. Thus, according to the power management system 50 according to the first variant of the second embodiment, power management can be performed in which by using correspondence information which is edited by the information processing apparatus 11 according to the embodiment of the present invention and which indicates pairs of terminals performing communication with special association, when a user of an end terminal 500 uses a shared terminal 600 over the network 700, the power to the shared terminal is turned on, ensuring convenience for the user, and when there is no data communication from the end terminal 500, the power to the shared terminal 600 is turned off, enabling power consumption saving.

Note that although description is made exemplifying the case of two end terminals 500 and two shared terminals 600, the numbers of end terminals 500 and those of shared terminals 600 are not limited thereto. Note also that when a single terminal serves as both an end terminal 500 and a shared terminal 600, too, by the information processing apparatus 11 monitoring the amount of communication of the terminal and by the terminal editing correspondence information indicating a communication relationship with special association, the power management system 50 according to the first variant of the second embodiment of the present invention can perform power management.

Note that when the information processing apparatus 11 edits correspondence information indicating a communication relationship with special association, set values such as the degree of past reference n, the weighting coefficient α, the threshold value TH1, and the threshold value TH2 may be held in the configuration information table 360 held in the memory 300, and when performing a correspondence information editing process, the editing unit 120 may refer to the set values from the configuration process table 360. In this case, by rewriting the configuration information table 360 held in the memory 300, the conditions for correspondence information editing performed by the information processing apparatus 11 according to the embodiment of the present invention can be changed.

### Second Variant of the Second Embodiment

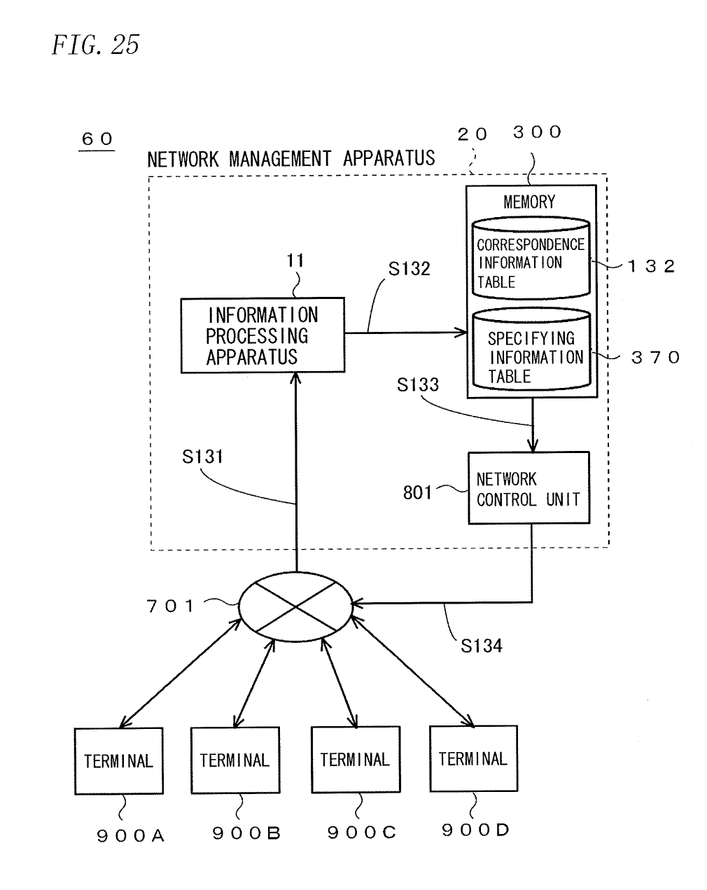

FIG. 25 is a block diagram schematically showing a configuration of a network management system 60 using an information processing apparatus 11 according to a second variant of the second embodiment. The network management system 60 includes a network management apparatus 20, terminals 900 (900A to 900D), and a network 701. The network management apparatus 20 further includes the information processing apparatus 11, a memory 300 which is holding means, and a network control unit 801 which is control means, and the memory 300 holds a correspondence information table 132 and a specifying information table 370. Here, the information processing apparatus 11 has the functions of the components shown in the block diagram of FIG. 12 and performs a correspondence information editing processing shown in the flowchart of FIG. 13. Note, however, that a storage unit 130 in FIG. 12 may be the same one as the memory 300 in FIG. 25.

The specifying information table 370 held in the memory 300 contains specifying information for the network 701. The specifying information is information specifying whether to allow communication between the plurality of terminals 900 connected to the network 701, and specifies, for example, information such as ‘communication from the terminal 900A to the terminal 900D is not performed’.

When communication between terminals 900 over the network 701 is performed, the information processing apparatus 11 observes the communication over the network 701 and edits correspondence information held in the correspondence information table 132, based on the number of communication packets in communication data S131 for the communication and communication source addresses and communication destination addresses contained in the communication packets (terminals having the source addresses are first apparatuses and terminals having the destination addresses are second apparatuses. Furthermore, this editing includes creation and deletion of correspondence information.).

Then, the network control unit 801 reads correspondence information and specifying information from the correspondence information table 132 and the specifying information table 370, respectively, to check whether a pair of terminals having a communication relationship in the correspondence information is a pair of terminals that is not allowed to perform communication in the specifications in the specifying information. Then, if the pair of terminals having a communication relationship in the correspondence information is a pair of terminals not allowed for communication, then the network control unit 801 determines that the pair of terminals is performing unauthorized communication with each other.

Furthermore, the network control unit 801 transmits a control signal S134 to the network 701 in order not to allow the terminals determined to be performing unauthorized communication to perform communication, thereby imposing limitations on communication on the network 701 in order not to allow the unauthorized communication to be performed. Hence, in communication over the network 701, when unauthorized communication other than communication specified in advance to be taken place is performed, the network management system 60 imposes limitations on the unauthorized communication, enabling the prevention of unauthorized communication in the network 701.

Here, for computation of an index value V used to edit correspondence information performed by the information processing apparatus 11 according to the second variant of the second embodiment, in order to find unauthorized communication performed in the past, it is desirable to perform computation of an index value V such that the value of the degree of past reference n is set to a large value and furthermore the weighting coefficient α is set to 1 or a value close to 1.

According to the information processing apparatus 11 according to the second variant of the second embodiment, as a communication source address and a communication destination address from a packet header of a detected communication packet, a source address and a destination address in the form of a MAC address and a source address and a destination address in the form of an IP address can be obtained. Since a MAC address is provided with an address that varies from terminal hardware to terminal hardware, when terminals are present in close layers to each other on a network, by using a MAC address, the information processing apparatus 11 can accurately identify which terminals are performing communication.

In addition, since an IP address is to identify a host on a network, by using an IP address, the information processing apparatus 11 can identify to which node in the network a target terminal is connected. Therefore, by using a combination of a MAC address and an IP address, the information processing apparatus 11 can appropriately identify terminals performing communication with each other.

As described above, by identifying the addresses of the source and destination terminals having performed communication, the information processing apparatus 11 of the second variant of the second embodiment of the present invention can accurately grasp which terminal apparatuses are performing communication with each other in a network. Furthermore, a determination can also be made as to whether the communication is performed by a pair of terminals allowed for communication which is described in correspondence information held in the correspondence information table 132. Thus, the network communication state can be diagnosed by determining whether communication is performed by terminal apparatuses that are originally supposed to perform communication and whether access is not made to terminal apparatuses that are not supposed to perform communication. Then, by checking terminals that are performing unauthorized communication, terminal apparatus setting error or malicious, unauthorized communication can be found. Thus, by using the amount of communication and communication terminal addresses which are detected by the information processing apparatus 11 of the second variant of the second embodiment of the present invention and its communication history, network trouble can be analyzed.

Note that the embodiments disclosed herein is to be considered in all respects as illustrative and not restrictive. The scope of the present invention is indicated by the appended claims rather than by the foregoing meanings, and all changes that come within the meanings and range of equivalency of the claims are therefore intended to be embraced therein.

### REFERENCE SIGNS LIST

1: POWER MANAGEMENT SYSTEM
10: POWER MANAGEMENT APPARATUS
100: CONTROL INSTRUCTION UNIT
200: MEMORY
310, 320, and 330: DETECTION APPARATUS
410, 420, and 430: CONTROL APPARATUS
510, 520, and 530: END TERMINAL
610, 620, and 630: SHARED TERMINAL
700: NETWORK
800: POWER STRIP
900: CPU
950: PROGRAM
11: INFORMATION PROCESSING APPARATUS
20: NETWORK MANAGEMENT APPARATUS
50: POWER MANAGEMENT SYSTEM
60: NETWORK MANAGEMENT SYSTEM
110: MONITORING UNIT
111: TRAFFIC MONITORING UNIT
112: TERMINAL INFORMATION OBTAINING UNIT
120: EDITING UNIT
130: STORAGE UNIT
131: PAST INFORMATION TABLE
132: CORRESPONDENCE INFORMATION TABLE
210: CPU
300: MEMORY
350: PROGRAM
370: SPECIFYING INFORMATION TABLE
400: CONTROL UNIT
500A and 500B: END TERMINAL
600A and 600B: SHARED TERMINAL
700 and 701: NETWORK
801: NETWORK CONTROL UNIT
900A to 900D: TERMINAL

1. A power management system that manages power states of apparatuses, the power management system comprising:
one or a plurality of first apparatuses;
one or a plurality of second apparatuses; and
a management apparatus, wherein
the management apparatus:
holds correspondence information in which one or a plurality of specific first apparatuses among the one or plurality of first apparatuses are associated with one or a plurality of specific second apparatuses among the one or plurality of second apparatuses, the one or plurality of specific second apparatuses performing data communication with the specific first apparatuses; and
obtains information about power states of the specific first apparatuses and controls power states of the specific second apparatuses based on the information.

2. The power management system according to claim 1, wherein when the management apparatus obtains information indicating that a power state of at least one of the specific first apparatuses is on, the management apparatus sets the power states of the specific second apparatuses to on.

3. The power management system according to claim 1, wherein when the management apparatus obtains information indicating that the power states of all of the specific first apparatuses are off, the management apparatus sets the power states of the specific second apparatuses to off.

4. The power management system according to claim 1, further comprising a control apparatus that controls the power states of the specific second apparatuses, wherein
the management apparatus transmits a predetermined signal to the control apparatus and thereby allows the control apparatus to control the power states of the specific second apparatuses.

5. The power management system according to claim 1, further comprising a detection apparatus that detects power states of the specific first apparatuses, wherein
the management apparatus obtains information about the power states of the specific first apparatuses from the detection apparatus.

6. The power management system according to claim 1, further comprising:
a detection apparatus that detects power states of the specific first apparatuses; and
a control apparatus that controls the power states of the specific second apparatuses, wherein
the management apparatus obtains information about the power states of the specific first apparatuses from the detection apparatus,
the management apparatus transmits a predetermined signal to the control apparatus and thereby allows the control apparatus to control the power states of the specific second apparatuses, and
the detection apparatus and the control apparatus are housed in a common casing.

7. The power management system according to claim 4, wherein when the management apparatus sets the power states of the specific second apparatuses to on, the predetermined signal transmitted to the control apparatus is a WOL (Wake On LAN) power control instruction.

8. The power management system according to claim 5, wherein the management apparatus obtains the information about the power states of the specific first apparatuses from the detection apparatus by power-line communication.

9. The power management system according to claim 5, wherein the management apparatus obtains the information about the power states of the specific first apparatuses from the detection apparatus by wireless communication.

10. The power management system according to claim 4, wherein the management apparatus transmits the predetermined signal to the control apparatus by power-line communication.

11. The power management system according to claim 4, wherein the management apparatus transmits the predetermined signal to the control apparatus by wireless communication.

12. A power management apparatus that manages power states of apparatuses, the power management apparatus comprising:
holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and
control means for obtaining information about power states of the specific first apparatuses and controlling power states of the specific second apparatuses based on the information.

13. A program causing a computer mounted on a power management apparatus that manages power states of apparatuses to function as:
holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and
control means for obtaining information about power states of the specific first apparatuses and controlling power states of the specific second apparatuses based on the information.

14. A power management method for managing power states of apparatuses, the power management method comprising:
a step (A) of holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses; and
a step (B) of obtaining information about power states of the specific first apparatuses and controlling power states of the specific second apparatuses based on the information.

15. An information processing apparatus that specifies a communication relationship between one or a plurality of first apparatuses and one or a plurality of second apparatuses, the information processing apparatus comprising:
observing means for observing communication conditions between the first apparatuses and the second apparatuses; and
editing means for editing, based on a result of the observation by the observing means, correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.

16. The information processing apparatus according to claim 15, wherein
the observing means has detecting means for detecting communication packets communicated between the first apparatuses and the second apparatuses, and
the editing means edits the correspondence information based on a number of communication packets detected by the detecting means during a unit of time.

17. The information processing apparatus according to claim 15, wherein
the observing means has detecting means for detecting communication packets communicated between the first apparatuses and the second apparatuses, and
the editing means edits the correspondence information based on a sum total of values each obtained by multiplying each of numbers of communication packets detected by the detecting means during a plurality of units of time, by a weighting value associated with each unit of time.

18. The information processing apparatus according to claim 16, wherein the editing means identifies a first apparatus and a second apparatus based on MAC (Media Access Control) addresses contained in a packet header of a communication packet detected by the detecting means, the first and second apparatuses being a source and a destination of the communication packet, respectively.

19. The information processing apparatus according to claim 16, wherein the editing means identifies a first apparatus and a second apparatus based on IP (Internet Protocol) addresses contained in a packet header of a communication packet detected by the detecting means, the first and second apparatuses being a source and a destination of the communication packet, respectively.

20. A power management apparatus that manages power states of apparatuses, the power management apparatus comprising:
holding means for holding correspondence information in which one or a plurality of specific first apparatuses among one or plurality of first apparatuses are associated with one or a plurality of specific second apparatuses among one or plurality of second apparatuses, the one or plurality of specific second apparatuses performing data communication with the specific first apparatuses;
control means for obtaining information about power states of the specific first apparatuses and controlling power states of the specific second apparatuses based on the information;
observing means for observing communication conditions between the first apparatuses and the second apparatuses; and
editing means for editing the correspondence information based on a result of the observation by the observing means.

21. A network management apparatus that manages communication on a network, the network management apparatus comprising:
holding means for holding correspondence information in which a first apparatus and a second apparatus among a plurality of apparatuses connected to the network are associated with each other, and specifying information specifying whether to allow communication between the plurality of apparatuses, the first apparatus being a source of data and the second apparatus being a destination of the data;
control means for controlling a communication state between the first apparatus and the second apparatus based on the correspondence information and the specifying information;
observing means for observing communication conditions between the plurality of apparatuses; and
editing means for editing the correspondence information based on a result of the observation by the observing means.

22. A program causing a computer mounted on an information processing apparatus that specifies a communication relationship between one or a plurality of first apparatuses and one or a plurality of second apparatuses to function as:
observing means for observing communication conditions between the first apparatuses and the second apparatuses, and
editing means for editing, based on a result of the observation by the observing means, correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.

23. An information processing method for specifying a communication relationship between one or a plurality of first apparatuses and one or a plurality of second apparatuses, the information processing method comprising:
a step (A) of observing communication conditions between the first apparatuses and the second apparatuses; and
a step (B) of editing, based on a result of the observation in the step (A), correspondence information in which one or a plurality of specific first apparatuses among the first apparatuses are associated with one or a plurality of specific second apparatuses among the second apparatuses, the one or plurality of specific second apparatuses having a communication relationship with the specific first apparatuses.
